(19) United States
(12) Patent Application Publication
(10) Pub. No.: US 2024/0012249 A1
(43) Pub. Date: Jan. 11, 2024

(54) DISPLAY DEVICE

(71) Applicant: Japan Display Inc., Tokyo (JP)

(72) Inventors: Hiroaki KIJIMA, Tokyo (JP); Yasuhiro TAKAHASHI, Tokyo (JP); Shinichi KOMURA, Tokyo (JP); Koichi OKUDA, Tokyo (JP)

(73) Assignee: Japan Display Inc., Tokyo (JP)

(21) Appl. No.: 18/348,436

(22) Filed: Jul. 7, 2023

(30) Foreign Application Priority Data
Jul. 8, 2022 (JP) 2022-110470
Apr. 20, 2023 (JP) 2023-069511

(51) Int. Cl. G02B 27/01; G02B 5/30; G02F 1/1335

(52) U.S. Cl. CPC G02B 27/0172; G02B 5/3083; G02F 1/133536; G02B 2027/0174; G02F 1/133541; G02F 1/133543

(57) ABSTRACT

According to one embodiment, a display device includes a display panel, a first retardation film that faces the display panel, a holographic optical element that is bonded to the first retardation film, a second retardation film that is bonded to the holographic optical element, and a reflective polarizer that faces the second retardation film, reflects first linearly polarized light, and transmits second linearly polarized light that is orthogonal to the first linearly polarized light, wherein an air layer is interposed between the second retardation film and the reflective polarizer, a surface of the second retardation film facing the reflective polarizer is covered with an antireflective film.

### CROSS-REFERENCE TO RELATED APPLICATIONS

This application is based upon and claims the benefit of priority from Japanese Patent Applications No. 2022-110470 filed Jul. 8, 2022; and No. 2023-069511 filed Apr. 20, 2023, the entire contents of all of which are incorporated herein by reference.

### FIELD

Embodiments described herein relate generally to a display device.

### BACKGROUND

In recent years, a technology of providing, for example, virtual reality (VR) by using a head-mounted display attached to a head part of a user has attracted attention. The head-mounted display is configured to display an image on a display provided in front of the eyes of the user. In this manner, the user wearing the head-mounted display can experience a virtual reality space with a realistic sensation.

### BRIEF DESCRIPTION OF THE DRAWINGS

FIG. 1 is a perspective view illustrating an example of an appearance of a head-mounted display 1 to which a display device according to a first embodiment is applied.

FIG. 2 is a diagram for explaining an overview of a configuration of the head-mounted display 1 illustrated in FIG. 1.

FIG. 3 is a sectional view illustrating a configuration example 1 of a display device DSP according to the first embodiment.

FIG. 4 is a diagram for explaining an optical effect of the display device DSP.

FIG. 5 is a diagram illustrating main components of an illumination device 3.

FIG. 6 is a sectional view illustrating a configuration example 2 of the display device DSP.

FIG. 7 is a sectional view illustrating a configuration example 3 of the display device DSP.

FIG. 8 is a sectional view illustrating a configuration example 4 of the display device DSP.

FIG. 9 is a sectional view illustrating a configuration example 5 of the display device DSP.

FIG. 10 is a diagram for explaining a ghost in a comparative example.

FIG. 11 is a diagram for explaining a ghost in a comparative example.

FIG. 12 is a diagram for explaining a ghost in a comparative example.

FIG. 13 is a diagram for explaining a ghost in a comparative example.

FIG. 14 is a sectional view illustrating a first configuration example of a display device DSP according to a second embodiment.

FIG. 15 is a sectional view illustrating an example of a liquid crystal element 10 illustrated in FIG. 14.

FIG. 16 is a plan view illustrating an example of an alignment pattern in a liquid crystal layer LC1 illustrated in FIG. 15.

FIG. 17 is a diagram for explaining an optical effect of the display device DSP.

FIG. 18 is a sectional view illustrating a second configuration example of the display device DSP according to the second embodiment.

FIG. 19 is a sectional view illustrating an example of an optical element 20 illustrated in FIG. 18.

FIG. 20 is a diagram for explaining an optical effect of the display device DSP.

FIG. 21 is a sectional view illustrating a first configuration example of a display device DSP according to a third embodiment.

FIG. 22 is a sectional view illustrating an example of an optical element 200 illustrated in FIG. 21 according to the third embodiment.

FIG. 23 is a sectional view illustrating an example of the optical element 200 illustrated in FIG. 21 according to the third embodiment.

FIG. 24 is a sectional view illustrating a modified example of the optical element 200 illustrated in FIG. 21.

FIG. 25 is a diagram for explaining an optical effect of the display device DSP according to the third embodiment.

FIG. 26 is a sectional view illustrating a second configuration example of a head-mounted display 1 according to the third embodiment.

FIG. 27 is a diagram for explaining a first optical element 200B, a second optical element 200G, and a third optical element 200R illustrated in FIG. 26.

FIG. 28 is a diagram for explaining an optical effect of the head-mounted display 1 illustrated in FIG. 26.

FIG. 29 is a sectional view illustrating a third configuration example of the head-mounted display 1.

FIG. 30 is a diagram for explaining an optical effect of the head-mounted display 1 illustrated in FIG. 29.

FIG. 31 is a sectional view illustrating a fourth configuration example of the display device DSP.

FIG. 32 is a sectional view illustrating an example of an optical element 30 illustrated in FIG. 31.

FIG. 33 is a diagram for explaining an optical effect of the display device DSP illustrated in FIG. 31.

FIG. 34 is a sectional view illustrating a first configuration example of a display device DSP according to a fourth embodiment.

FIG. 35 is a diagram for explaining an example of an optical effect of the display device DSP illustrated in FIG. 34.

FIG. 36 is a sectional view illustrating a second configuration example of the display device DSP according to the fourth embodiment.

FIG. 37 is a diagram for explaining an example of an optical effect of the display device DSP illustrated in FIG. 36.

FIG. 38 is a diagram for explaining a first specific angle of incidence θ1 of a first holographic optical element HE1 and a second specific angle of incidence θ2 of a second holographic optical element HE2 illustrated in FIG. 37.

### DETAILED DESCRIPTION

According to one embodiment, a display device includes
a display panel configured to emit display light that is linearly polarized light;
a first retardation film that faces the display panel;
a holographic optical element that is bonded to the first retardation film;
a second retardation film that is bonded to the holographic optical element; and
a reflective polarizer that faces the second retardation film, reflects first linearly polarized light, and transmits second linearly polarized light that is orthogonal to the first linearly polarized light, wherein
an air layer is interposed between the second retardation film and the reflective polarizer,
a surface of the second retardation film facing the reflective polarizer is covered with an antireflective film.

According to another embodiment, a display device includes
a display panel configured to emit display light that is linearly polarized light;
a first retardation film that faces the display panel;
a holographic optical element that is bonded to the first retardation film;
a second retardation film that faces the holographic optical element; and
a reflective polarizer that is bonded to the second retardation film, reflects first linearly polarized light, and transmits second linearly polarized light that is orthogonal to the first linearly polarized light, wherein
an air layer is interposed between the holographic optical element and the second retardation film,
each of a surface of the holographic optical element facing the second retardation film and a surface of the second retardation film facing the holographic optical element is covered with an antireflective film.

According to another embodiment, a display device includes
a display panel configured to emit display light that is linearly polarized light;
a first retardation film that faces the display panel;
a holographic optical element that faces the first retardation film;
a second retardation film that faces the holographic optical element; and
a reflective polarizer that faces the second retardation film, reflects first linearly polarized light, and transmits second linearly polarized light that is orthogonal to the first linearly polarized light, wherein
air layers is interposed each between the first retardation film and the display panel, between the holographic optical element and the first retardation film, between the second retardation film and the holographic optical element, and between the reflective polarizer and the second retardation film,
each of a surface of the first retardation film facing the display panel, a surface of the first retardation film facing the holographic optical element, a surface of the holographic optical element facing the first retardation film, a surface of the holographic optical element facing the second retardation film, a surface of the second retardation film facing the holographic optical element, and a surface of the second retardation film facing the reflective polarizer being covered with an antireflective film.

An object of the embodiments is to provide a display device capable of suppressing degradation in display quality.

Embodiments will be described hereinafter with reference to the accompanying drawings. The disclosure is merely an example, and proper changes within the spirit of the invention, which are easily conceivable by a skilled person, are included in the scope of the invention as a matter of course. In addition, in some cases, in order to make the description clearer, the widths, thicknesses, shapes, etc., of the respective parts are schematically illustrated in the drawings, compared to the actual modes. However, the schematic illustration is merely an example, and adds no restrictions to the interpretation of the invention. Besides, in the specification and drawings, the same or similar elements as or to those described in connection with preceding drawings or those exhibiting similar functions are denoted by like reference numerals, and a detailed description thereof is omitted unless otherwise necessary.

The embodiments described herein are not general ones, but rather embodiments that illustrate the same or corresponding special technical features of the invention. The following is a detailed description of one embodiment of a display device with reference to the drawings.

Note that, in order to make the descriptions more easily understandable, some of the drawings illustrate an X axis, a Y axis and a Z axis orthogonal to each other. A direction along the X axis is referred to as an X direction or a first direction, a direction along the Y axis is referred to as a Y direction or a second direction and direction along the Z axis is referred to as a Z direction or a third direction. A plane defined by the X axis and the Y axis is referred to as an X-Y plane, and viewing towards the X-Y plane is referred to as planar view. The first direction X, the second direction Y and the third direction Z are orthogonal to each other, but may intersect at an angle other than 90 degrees. The direction toward the tip of the arrow in the third direction Z is defined as up or above, and the direction opposite to the direction toward the tip of the arrow in the third direction Z is defined as down or below. The first direction X, the second direction Y, and the third direction Z may as well be referred to as an X direction, a Y direction and a Z direction, respectively.

Further, with such expressions as “the second member above the first member” and “the second member below the first member”, the second member may be in contact with the first member or may be located away from the first member. In the latter case, a third member may be interposed between the first member and the second member. On the other hand, with such expressions as “the second member on the first member” and “the second member beneath the first member”, the second member is in contact with the first member.

Further, it is assumed that there is an observation position to observe the display device on a tip side of the arrow in the third direction Z. Here, viewing from this observation position toward the X-Z plane defined by the first direction X and the third direction Z, or a cross-section of the display device in the Y-Z plane defined by the second direction Y and the third direction Z is referred to as cross-sectional view.

### First Embodiment

FIG. 1 is a perspective view illustrating an example of an appearance of a head-mounted display 1 to which a display device according to a first embodiment is applied.

The head-mounted display 1 includes, for example, a display device DSPR for a right eye and a display device DSPL for a left eye. In a state where a user is wearing the head-mounted display 1 on his/her head part, the display device DSPR is disposed to be positioned in front of the right eye of the user, and the display device DSPL is disposed to be positioned in front of the left eye of the user.

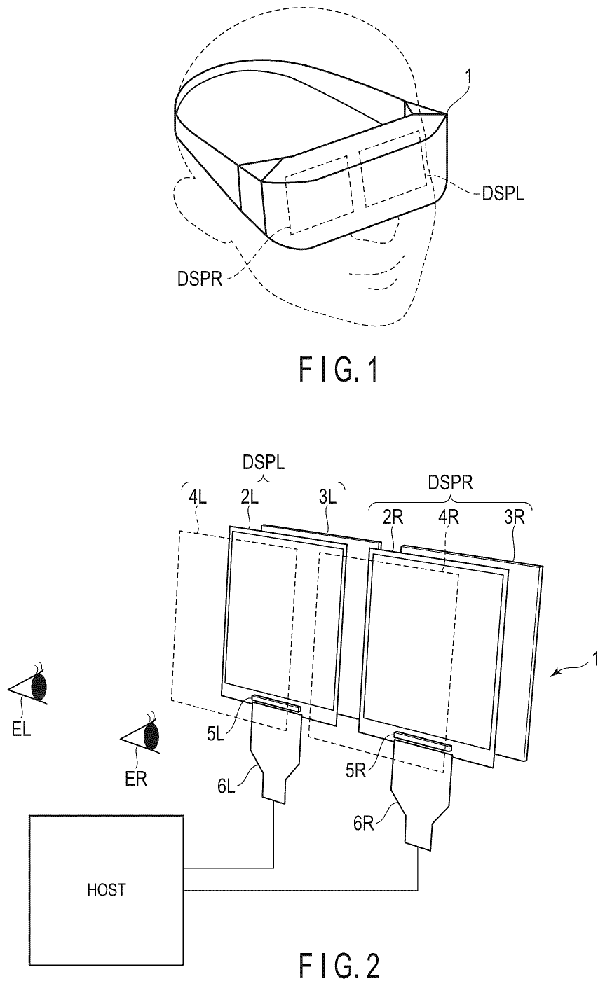

FIG. 2 is a diagram for explaining an overview of a configuration of the head-mounted display 1 illustrated in FIG. 1.

The display device DSPR includes a display panel 2R, an illumination device 3R, and an optical system 4R illustrated by the dashed line. The illumination device 3R is disposed on the rear surface of the display panel 2R and is configured to illuminate the display panel 2R. The optical system 4R is disposed on the front surface of the display panel 2R (or between the right eye ER of the user and the display panel 2R) and is configured to guide display light from the display panel 2R to the right eye ER.

The display panel 2R includes, for example, a liquid crystal panel and a polarizer. The display panel 2R is interposed between the illumination device 3R and the optical system 4R. A driver IC chip 5R and a flexible printed circuit 6R, for example, are connected to the display panel 2R. The driver IC chip 5R controls driving of the display panel 2R (particularly, controls a display operation of the display panel 2R).

The display device DSPL includes a display panel 2L, an illumination device 3L, and an optical system 4L illustrated by the dashed line. The illumination device 3L is disposed on the rear surface of the display panel 2L and is configured to illuminate the display panel 2L. The optical system 4L is disposed on the front surface of the display panel 2L (or between the left eye EL of the user and the display panel 2L) and is configured to guide display light from the display panel 2L to the left eye EL.

The display panel 2L includes, for example, a liquid crystal panel and a polarizer. The display panel 2L is interposed between the illumination device 3L and the optical system 4L. A driver IC chip 5L and a flexible printed circuit 6L, for example, are connected to the display panel 2L. The driver IC chip controls driving of the display panel 2L (particularly, controls a display operation of the display panel 2L).

The display device DSPR is configured substantially similarly to the display device DSPL.

In other words, the display panel 2R, the illumination device 3R, and the optical system 4R configuring the display device DSPR are configured similarly to the display panel 2L, the illumination device 3L, and the optical system 4L configuring the display device DSPL, respectively.

In the display device DSP according to the first embodiment, the display panel 2R and the display panel 2L are not limited to the example in which they include the liquid crystal panels and may include display panels including self-luminous light emitting elements such as display panels including organic electroluminescent (EL) elements, micro-LEDs, or mini LEDs. In a case where the display panel 2R and the display panel 2L are display panels including light emitting elements, the illumination device 3R and the illumination device 3L are omitted. Although details will be described later, the display panel 2R and the display panel 2L are configured to emit display light that is linearly polarized light and include polarizers as needed.

An externally provided host computer HOST is connected to each of the display panel 2L and the display panel 2R. The host computer HOST outputs image data corresponding to images to be displayed on the display panel 2L and the display panel 2R. The image displayed on the display panel 2L is an image for the left eye (or an image visually recognized by the left eye EL of the user). In addition, the image displayed on the display panel 2R is an image for the right eye (or an image visually recognized by the right eye ER of the user).

In a case where the head-mounted display 1 is used for VR, for example, the image for the left eye and the image for the right eye are images that reproduce disparity between both the eyes and are similar to each other. In a case where the image for the left eye displayed on the display panel 2L is visually recognized by the left eye EL of the user and the image for the right eye displayed on the display panel 2R is visually recognized by the right eye ER of the user, the user can recognize a stereoscopic space (three-dimensional space) as a virtual reality space.

Incidentally, the display panel 2R and the display panel 2L may be configured as a single display panel extending from the front of the left eye EL to the front of the right eye ER. In addition, the illumination device 3R and the illumination device 3L may be configured as a single illumination device extending from the front of the left eye EL to the front of the right eye ER.

Next, some configuration examples of the display device DSP according to the present embodiment will be described.

### Configuration Example 1

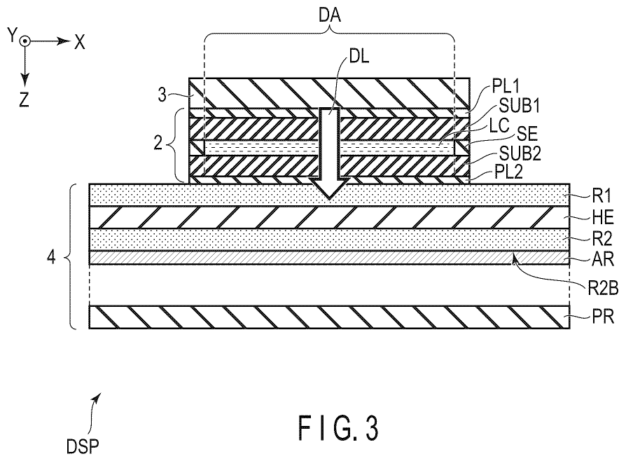

FIG. 3 is a sectional view illustrating a configuration example 1 of the display device DSP.

The display device DSP includes a display panel 2, an illumination device 3, and an optical system 4. Incidentally, detailed illustration of the display panel 2 and the illumination device 3 is omitted here. The display device DSP described here can be applied to each of the display device DSPR and the display device DSPL described above. In addition, the display panel 2 can be applied to each of the display panel 2R and the display panel 2L described above. In addition, the illumination device 3 can be applied to each of the illumination device 3R and the illumination device 3L described above. In addition, the optical system 4 can be applied to each of the optical system 4R and the optical system 4L described above.

The display panel 2 is formed into a flat plate shape extending in an X-Y plane. The display panel 2 includes a first substrate SUB1, a second substrate SUB2, a liquid crystal layer LC, a first polarizer PL1, and a second polarizer PL2. The first substrate SUB1 and the second substrate SUB2 face each other in a third direction Z. The liquid crystal layer LC is held between the first substrate SUB1 and the second substrate SUB2 and is sealed by a sealant SE. The first polarizer PL1 is interposed between the illumination device 3 and the first substrate SUB1 and is bonded to the first substrate SUB1, for example. The second polarizer PL2 is interposed between the second substrate SUB2 and the optical system 4 and is bonded to the second substrate SUB2, for example.

The display panel 2 includes a display area DA configured to emit display light DL that is linearly polarized light. The display area DA is configured to selectively modulate illumination light from the illumination device 3. A part of the illumination light is transmitted through the second polarizer PL2 and is converted into the display light DL that is linearly polarized light.

The display panel 2 is not limited to a liquid crystal panel not only in the configuration example 1 described here but also in the other configuration examples in a similar manner. In a case where the display panel 2 is a display panel including a self-luminous light emitting element such as an organic EL element, the illumination device 3 is omitted as described above. In addition, the display light DL emitted from the light emitting element is transmitted through the second polarizer PL2 and is converted into the display light DL that is linearly polarized light in this case.

The optical system 4 includes a first retardation film R1, a holographic optical element HE, a second retardation film R2, and a reflective polarizer PR. The first retardation film R1, the holographic optical element HE, the second retardation film R2, and the reflective polarizer PR extend over a wider range than the display panel 2 in the X-Y plane.

The first retardation film R1 and the second retardation film R2 are quarter-wave plates and are adapted to impart a phase difference of a quarter wavelength to transmitted light. The first retardation film R1 is disposed to face at least the display area DA in the X-Y plane. The first retardation film R1 faces the display panel 2 in the third direction Z. In the example illustrated in FIG. 3, the first retardation film R1 is bonded to the display panel 2 or the second polarizer PL2. The second retardation film R2 is spaced apart from the first retardation film R1 and faces it with a gap therebetween in the third direction Z.

The holographic optical element HE reflects and diffracts a part of incident light and has a lens effect of collecting light. The holographic optical element HE has an interference fringe pattern and is adapted to diffract incident light in a predetermined direction. The holographic optical element HE faces the first retardation film R1 in the third direction Z and is bonded to the first retardation film R1. The second retardation film R2 faces the holographic optical element HE in the third direction Z and is bonded to the holographic optical element HE. In other words, the holographic optical element HE is located between the first retardation film R1 and the second retardation film R2.

The reflective polarizer PR is adapted to reflect first linearly polarized light and transmits second linearly polarized light that is orthogonal to the first linearly polarized light out of incident light. For example, the reflective polarizer PR is of a multilayer thin-film type, a wire grid type, or the like. The reflective polarizer PR faces the second retardation film R2 in the third direction Z and is spaced apart from the second retardation film R2. In other words, an air layer is interposed between the second retardation film R2 and the reflective polarizer PR.

In such a configuration example 1, a surface R2B of the second retardation film R2 facing the reflective polarizer PR is covered with an antireflective film AR. For this reason, it is possible to suppress undesirable reflection or refraction at an interface between the second retardation film R2 and the air layer.

Although the first retardation film R1 and the second retardation film R2 are adapted to impart a phase difference of a quarter wavelength to at least light of a green wavelength, for example, they are not limited thereto. For example, it is possible to apply retardation films of a broadband type imparting a phase difference of an approximately quarter wavelength to light of each of a red wavelength, a green wavelength, and a blue wavelength as the first retardation film R1 and the second retardation film R2. As such retardation films of a broadband type, it is possible to apply retardation films obtained by attaching quarter-wave plates and half-wave plates in a state where a slow axis of the quarter-wave plates and a slow axis of the half-wave plates form a predetermined angle, for example. It is thus possible to reduce wavelength dependency of the first retardation film R1 and the second retardation film R2.

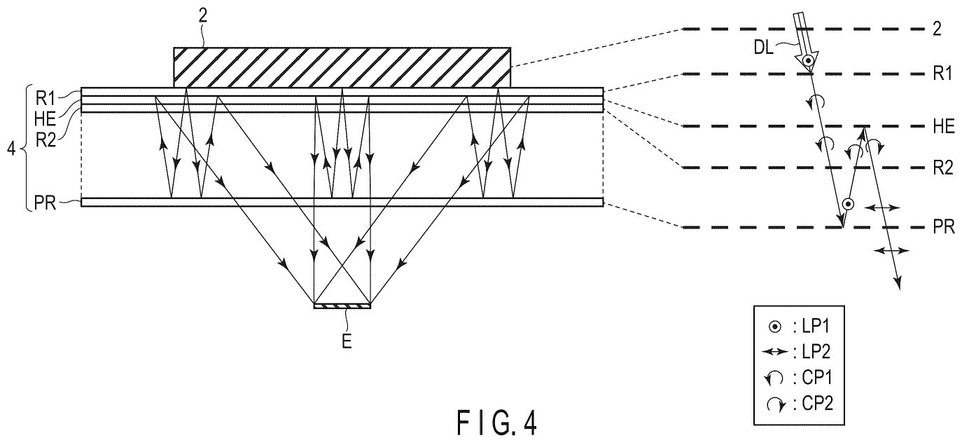

FIG. 4 is a diagram for explaining an optical effect of the display device DSP. Incidentally, illustration of the illumination device 3 and the antireflective film AR is omitted in FIG. 4.

First, the display panel 2 emits display light DL that is first linearly polarized light LP1. The first linearly polarized light LP1 here is linearly polarized light oscillating in a direction perpendicular to the drawing, for example. A phase difference of a quarter wavelength is imparted to the display light DL when the display light is transmitted through the first retardation film R1. In this manner, the display light DL is converted into first circularly polarized light CP1 after being transmitted through the first retardation film R1. The first circularly polarized light CP1 here is counterclockwise circularly polarized light, for example.

A part of the first circularly polarized light CP1 transmitted through the first retardation film R1 is then transmitted through the holographic optical element HE. A phase difference of a quarter wavelength is imparted to the first circularly polarized light CP1 transmitted through the holographic optical element HE, and the first circularly polarized light CP1 is then converted into the first linearly polarized light LP1 again, when the first circularly polarized light CP1 is transmitted through the second retardation film R2.

The first linearly polarized light LP1 transmitted through the second retardation film R2 is reflected by the reflective polarizer PR. The first linearly polarized light LP1 reflected by the reflective polarizer PR is transmitted through the second retardation film R2 and is converted into the first circularly polarized light CP1. A part of the first circularly polarized light CP1 transmitted through the second retardation film R2 is reflected by the holographic optical element HE and is then converted into second circularly polarized light CP2. The second circularly polarized light CP2 here is circularly polarized light in the direction opposite to the first circularly polarized light CP1 and is clockwise circularly polarized light, for example.

The second circularly polarized light CP2 reflected by the holographic optical element HE is transmitted through the second retardation film R2 and is then converted into second linearly polarized light LP2. The second linearly polarized light LP2 here is linearly polarized light that oscillates in a direction that is orthogonal to the first linearly polarized light LP1, that is, a direction that is parallel to the drawing (the sheet).

The second linearly polarized light LP2 transmitted through the second retardation film R2 is transmitted through the reflective polarizer PR. The light transmitted through the reflective polarizer PR is reflected light from the holographic optical element HE and is collected on the user's pupil (eye) E by an effect of a concave mirror.

According to such a display device DSP, the optical system 4 includes an optical path passing between the holographic optical element HE and the reflective polarizer PR three times. In other words, the optical distance between the holographic optical element HE and the reflective polarizer PR is about three times the actual interval between the holographic optical element HE and the reflective polarizer PR in the optical system 4. The holographic optical element HE has a lens effect of collecting light, and light reflected by the holographic optical element HE is thus collected on the user's pupil E. The user can thus observe an enlarged virtual image.

In order to secure the distance between the holographic optical element HE and the reflective polarizer PR, the air layer is interposed between the second retardation film R2 and the reflective polarizer PR in the configuration example 1. In such an optical system 4, undesirable reflected light at the interface between the second retardation film R2 and the air layer may cause multiple images (so-called ghosts) and may lead to degradation in display quality. On the other hand, according to the configuration example 1, the second retardation film R2 is provided with the antireflective film AR, undesirable reflected light does thus not occur, and it is possible to suppress degradation in display quality.

In addition, since wavelength dependency of each member configuring the optical system 4 is low, it is possible to simplify the configuration of the optical system 4 and to efficiently collect light for a color image to be displayed in the display area DA on the user's pupil E.

Incidentally, the first linearly polarized light LP1 described with reference to FIG. 4 may be replaced with the second linearly polarized light LP2, and the first circularly polarized light CP1 may be replaced with the second circularly polarized light CP2.

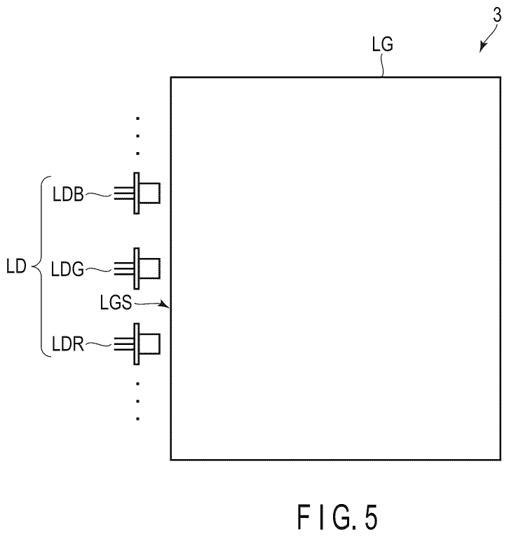

FIG. 5 is a diagram illustrating main components of the illumination device 3.

The illumination device 3 includes a light guide LG and a plurality of light emitting elements LD. Each of the plurality of light emitting elements LD faces a side surface LGS of the light guide LG.

The light emitting elements LD include a first light emitting element (also referred to as a first laser element) LDB configured to emit laser light of the blue wavelength (first wavelength), a second light emitting element (also referred to as a second laser element) LDG configured to emit laser light of the green wavelength (second wavelength), and a third light emitting element (third laser element) LDR configured to emit laser light of the red wavelength (third wavelength). The first light emitting element LDB, the second light emitting element LDG, and the third light emitting element LDR are arranged and spaced apart from each other.

A center wavelength of the blue laser light emitted from the first light emitting element LDB is defined as λb, a center wavelength of the green laser light emitted from the second light emitting element LDG is defined as λg, and a center wavelength of the red laser light emitted from the third light emitting element LDR is defined as λr.

The holographic optical element HE is optimized to reflect first circularly polarized light CP1 of the center wavelength λb, a first circularly polarized light CP1 of the center wavelength λg, and first circularly polarized light CP1 of the center wavelength λr.

Incidentally, the illumination device 3 may be configured such that the plurality of light emitting elements LD are disposed directly under the display panel 2.

Next, another configuration example of the display device DSP will be described. Incidentally, the same configurations as those in the configuration example 1 may be denoted by the same reference signs, and description thereof may be omitted, in the following description. In addition, illustration of the illumination device 3 is omitted. In addition, although each of the display panel 2, the first retardation film R1, the holographic optical element HE, the second retardation film R2, and the reflective polarizer PR is illustrated in a simplified manner, various optical members such as the holographic optical element HE extends in a wider range than the display panel 2 in the X-Y plane as shown in FIG. 3.

### Configuration Example 2

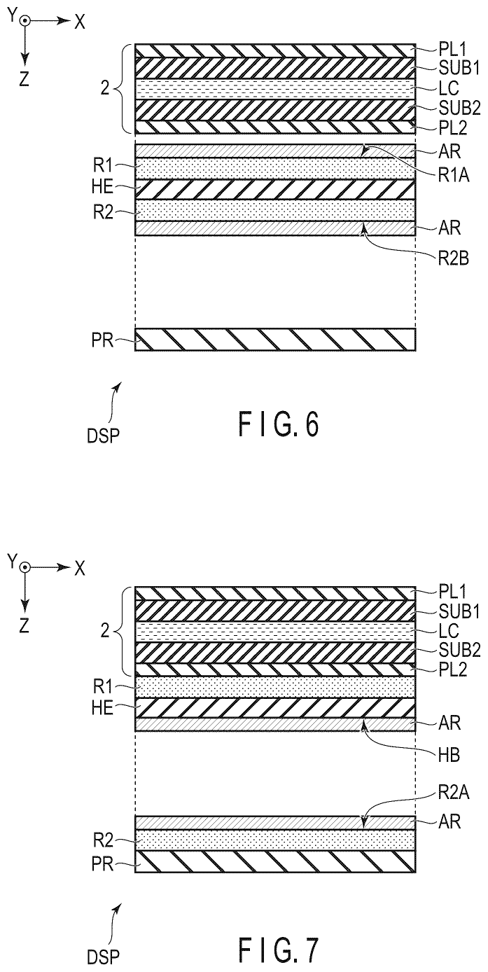

FIG. 6 is a sectional view illustrating a configuration example 2 of the display device DSP.

The configuration example 2 illustrated in FIG. 6 is different from the configuration example 1 illustrated in FIG. 3 in that an air layer is interposed between the first retardation film R1 and the display panel 2. In other words, the first retardation film R1 faces the display panel 2 in the third direction Z and is spaced apart from the display panel 2 or the second polarizer PL2.

In such a configuration example 2, a surface R1A of the first retardation film R1 facing the display panel 2 is covered with the antireflective film AR. For this reason, it is possible to suppress undesirable reflection or refraction at an interface between the first retardation film R1 and the air layer.

### Configuration Example 3

FIG. 7 is a sectional view illustrating a configuration example 3 of the display device DSP.

The first retardation film R1 faces the display panel 2 in the third direction Z. In the example illustrated in FIG. 7, the first retardation film R1 is bonded to the display panel 2 or the second polarizer PL2. The second retardation film R2 is spaced apart from the first retardation film R1 and faces it with a gap therebetween in the third direction Z.

The holographic optical element HE faces the first retardation film R1 in the third direction Z and is bonded to the first retardation film R1. The second retardation film R2 faces the holographic optical element HE in the third direction Z and is spaced apart from the holographic optical element HE. In other words, an air layer is interposed between the holographic optical element HE and the second retardation film R2.

The reflective polarizer PR faces the second retardation film R2 in the third direction Z and is bonded to the second retardation film R2.

In such a configuration example 3, a surface HB of the holographic optical element HE facing the second retardation film R2 is covered with the antireflective film AR. In addition, a surface R2A of the second retardation film R2 facing the holographic optical element HE is covered with the antireflective film AR. For this reason, it is possible to suppress undesirable reflection or refraction at an interface between the holographic optical element HE and the air layer and the interface between the second retardation film R2 and the air layer.

### Configuration Example 4

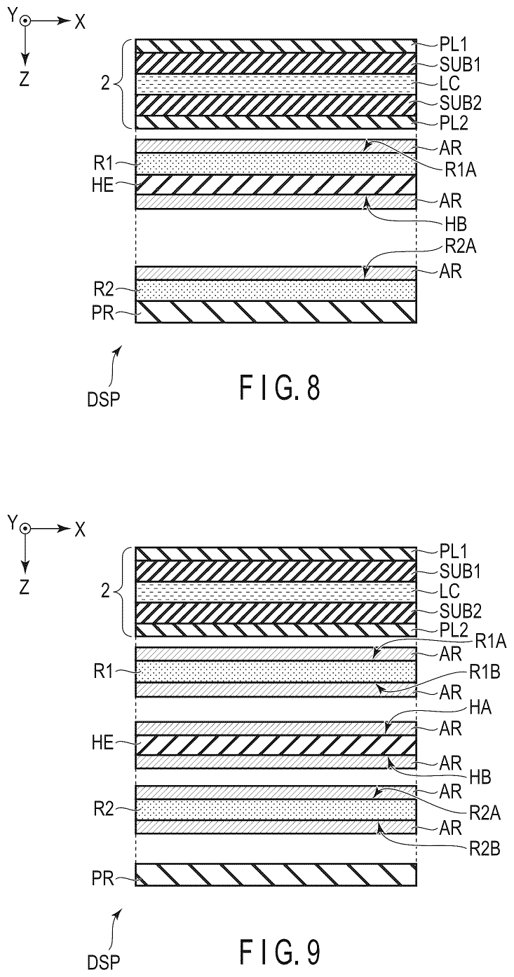

FIG. 8 is a sectional view illustrating a configuration example 4 of the display device DSP.

The configuration example 4 illustrated in FIG. 8 is different from the configuration example 3 illustrated in FIG. 7 in that an air layer is interposed between the first retardation film R1 and the display panel 2. In other words, the first retardation film R1 faces the display panel 2 in the third direction Z and is spaced apart from the display panel 2 or the second polarizer PL2.

In such a configuration example 4, the surface R1A of the first retardation film R1 facing the display panel 2 is covered with the antireflective film AR. For this reason, it is possible to suppress undesirable reflection or refraction at an interface between the first retardation film R1 and the air layer.

### Configuration Example 5

FIG. 9 is a sectional view illustrating a configuration example 5 of the display device DSP.

The first retardation film R1 faces the display panel 2 in the third direction Z and is spaced apart from the display panel 2 or the second polarizer PL2.

The holographic optical element HE faces the first retardation film R1 in the third direction Z and is spaced apart from the first retardation film R1.

The second retardation film R2 faces the holographic optical element HE in the third direction Z and is spaced apart from the holographic optical element HE.

The reflective polarizer PR faces the second retardation film R2 in the third direction Z and is spaced apart from the second retardation film R2.

In other words, an air layer is interposed at each of parts between the first retardation film R1 and the display panel 2, between the holographic optical element HE and the first retardation film R1, between the second retardation film R2 and the holographic optical element HE, and between the reflective polarizer PR and the second retardation film R2 in the configuration example 5.

Each of a surface R1A of the first retardation film R1 facing the display panel 2 and a surface R1B thereof facing the holographic optical element HE is covered with the antireflective film AR.

Each of a surface HA of the holographic optical element HE facing the first retardation film R1 and a surface HB thereof facing the second retardation film R2 is covered with the antireflective film AR.

Each of a surface R2A of the second retardation film R2 facing the holographic optical element HE and a surface R2B thereof facing the reflective polarizer PR is covered with the antireflective film AR.

For this reason, it is possible to suppress undesirable reflection or refraction at an interface between the first retardation film R1 and the air layer, at an interface between the holographic optical element HE and the air layer, and at an air interface between the second retardation film R2 and the air layer.

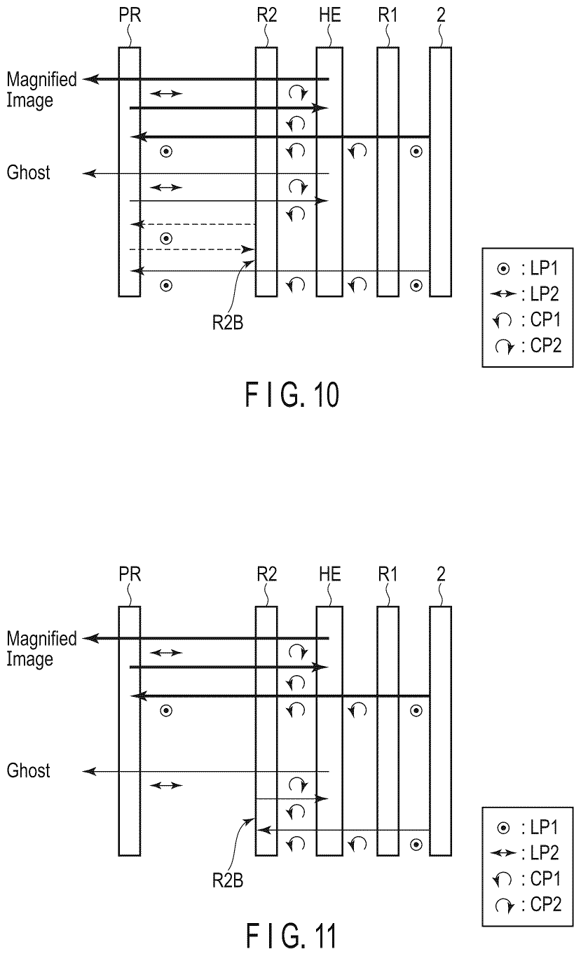

Next, a comparative example will be described. In comparative examples illustrated in FIGS. 10 to 13, the first retardation film R1 is spaced apart from the display panel 2, the holographic optical element HE is spaced apart from the first retardation film R1, the second retardation film R2 is separated from the holographic optical element HE, and the reflective polarizer PR is spaced apart from the second retardation film R2. In addition, the first retardation film R1, the holographic optical element HE, and the second retardation film R2 are not provided with antireflective films.

Hereinafter, ghosts that may occur will be described in the comparative examples with reference to FIGS. 10 to 13. Incidentally, an optical path forming a normal enlarged image is illustrated by a thick line, and an optical path forming a ghost is illustrated by a thin line, in each drawing.

In the example illustrated in FIG. 10, the first linearly polarized light LP1 reflected by the reflective polarizer PR is reflected by the surface R2B of the second retardation film R2 facing the reflective polarizer PR. In other words, an optical path reciprocating between the second retardation film R2 and the reflective polarizer PR is added as illustrated by the dashed line. For this reason, the optical path length is extended as compared with the optical path for the normal enlarged image. In such a case, a further enlarged ghost occurs in addition to the normal enlarged image.

In the example illustrated in FIG. 11, the first circularly polarized light CP1 transmitted through the holographic optical element HE is reflected by the surface R2B of the second retardation film R2 facing the reflective polarizer PR. In other words, the optical path reciprocating between the second retardation film R2 and the reflective polarizer PR is missing. For this reason, a ghost occurs through an optical path that is different from the optical path for the normal enlarged image.

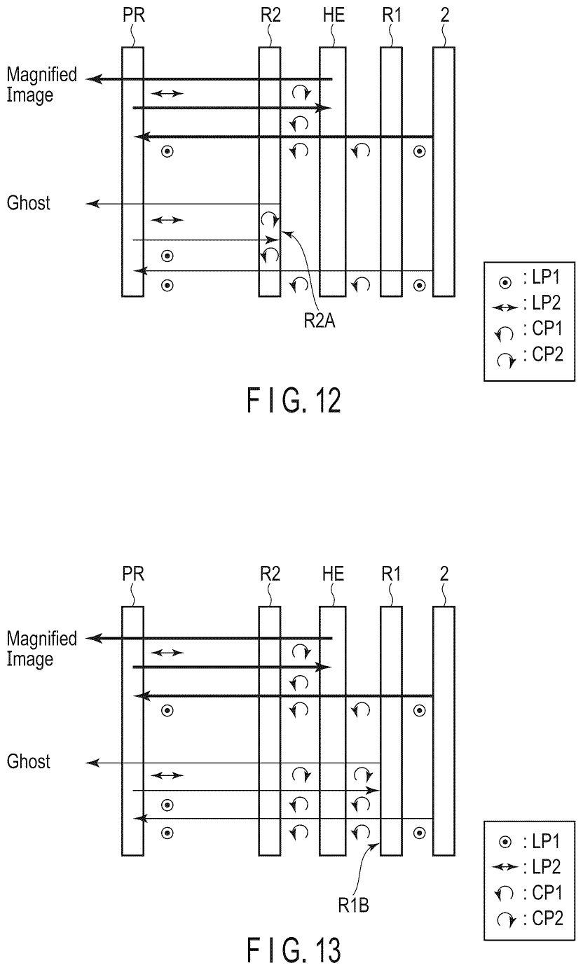

In the example illustrated in FIG. 12, the first linearly polarized light LP1 reflected by the reflective polarizer PR is reflected by the surface R2A of the second retardation film R2 facing the holographic optical element HE. In other words, the optical path reciprocating between the second retardation film R2 and the holographic optical element HE is missing. For this reason, a ghost occurs through an optical path that is different from the optical path for the normal enlarged image.

In the example illustrated in FIG. 13, the first linearly polarized light LP1 reflected by the reflective polarizer PR is converted into the first circularly polarized light CP1 by the second retardation film R2, is then transmitted through the holographic optical element HE, and is reflected by the surface R1B of the first retardation film R1 facing the holographic optical element HE. In other words, an optical path reciprocating between the holographic optical element HE and the first retardation film R1 is added. For this reason, a ghost occurs through an optical path that is different from the optical path for the normal enlarged image.

As described above, according to the present embodiment, each optical member configuring the optical system 4 is covered with the antireflective film, and an interface with the air layer is not formed. For this reason, occurrence of a ghost in addition to the normal enlarged image is suppressed, and it is possible to suppress degradation in display quality.

### Second Embodiment

In a second embodiment, a display device DSP using an optical system 4 that is different from that in the first embodiment will be described.

Incidentally, the first embodiment will be referred to for components that are similar to those in the first embodiment, and description of these components will be omitted.

### First Configuration Example

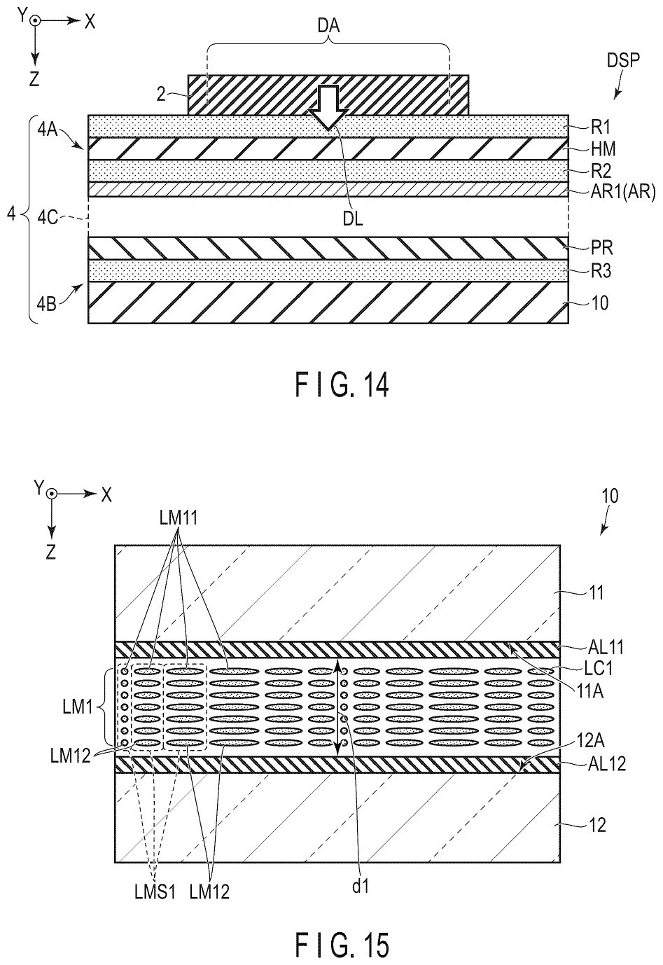

FIG. 14 is a sectional view illustrating a first configuration example of the display device DSP according to the second embodiment.

The display device DSP includes a display panel 2 and an optical system 4. Incidentally, detailed illustration of the display panel 2 is omitted, and illustration of an illumination device is omitted, in FIG. 14. The optical system 4 can be applied to each of the optical system 4R and the optical system 4L described above.

The optical system 4 includes a first structure 4A and a second structure 4B. The first structure 4A is spaced apart from the second structure 4B. In the example illustrated in FIG. 14, an air layer 4C is provided between the first structure 4A and the second structure 4B. The first structure 4A is interposed between the display panel 2 and the second structure 4B (or between the display panel 2 and the air layer 4C).

The first structure 4A includes a first retardation film R1, a transflective layer (semi-transparent layer) HM, a second retardation film R2, and an antireflective film AR. The first retardation film R1 and the second retardation film R2 are quarter-wave plates and are adapted to impart a phase difference of a quarter wavelength to transmitted light. The transflective layer HM is adapted to transmit a part of incident light and reflect other light. For example, the transflective layer HM is a thin film formed of a metal material such as aluminum or silver. In addition, the transmittance of the transflective layer HM is about 50%.

The antireflective film AR is provided to be in contact with the second retardation film R2. More specifically, a surface of the second retardation film R2 facing the reflective polarizer PR is covered with an antireflective film AR. Similarly to the first embodiment, undesirable reflected light does not occur, and it is possible to suppress degradation in display quality in the second embodiment as well.

Incidentally, the antireflective film AR provided at the first structure 4A may be referred to as an antireflective film AR1 in FIG. 14.

The first retardation film R1, the transflective layer HM, the second retardation film R2, and the antireflective film AR extend in a wider range than a display area DA in the X-Y plane. In addition, the first retardation film R1, the transflective layer HM, the second retardation film R2, and the antireflective film AR are laminated in this order in the third direction Z. The first retardation film R1 is in contact with the display panel 2. The transflective layer HM is in contact with the first retardation film R1. The second retardation film R2 is in contact with the transflective layer HM. The antireflective film AR is in contact with the second retardation film R2.

The first retardation film R1 is interposed between the display panel 2 and the transflective layer HM. The transflective layer HM is interposed between the first retardation film R1 and the second retardation film R2. The second retardation film R2 is interposed between the transflective layer HM and the antireflective film AR.

The second structure 4B includes a reflective polarizer PR, a third retardation film R3, and a liquid crystal element 10. The reflective polarizer PR is adapted to transmit the first linearly polarized light and reflect the second linearly polarized light that is orthogonal to the first linearly polarized light out of incident light. For example, the reflective polarizer PR is of a multilayer thin-film type, a wire grid type, or the like. The third retardation film R3 is a quarter-wave plate and is adapted to impart a phase difference of a quarter wavelength to transmitted light.

The liquid crystal element 10 imparts a phase difference of a half wavelength to light of a specific wavelength and has a lens effect of collecting the first circularly polarized light. Incidentally, although the liquid crystal element 10 has been described as an example of the element having a lens effect of collecting the circularly polarized light here, the element is not limited to the element using a liquid crystal as long as it has an equivalent lens effect.

The reflective polarizer PR, the third retardation film R3, and the liquid crystal element 10 extend in a wider range than the display area DA in the X-Y plane. In addition, the reflective polarizer PR, the third retardation film R3, and the liquid crystal element 10 are laminated in this order in the third direction Z. The third retardation film R3 is in contact with the reflective polarizer PR, the liquid crystal element 10 is in contact with the third retardation film R3, the second retardation film R2 is interposed between the transflective layer HM and the reflective polarizer PR, and the third retardation film R3 is interposed between the reflective polarizer PR and the liquid crystal element 10. The reflective polarizer PR is spaced apart from the second retardation film R2 and faces the second retardation film R2 via an air layer 4C in the third direction Z.

It is desirable that the display panel 2 and the first retardation film R1 be in close contact with each other without intervention of any air layer. In addition, it is desirable that the first retardation film R1, the transflective layer HM, the second retardation film R2, and the antireflective film AR configuring the first structure 4A be in close contact with each other without intervention of any air layer. Moreover, it is desirable that the reflective polarizer PR, the third retardation film R3, and the liquid crystal element 10 configuring the second structure 4B be in close contact with each other without intervention of any air layer. It is thus possible to suppress undesirable reflection or refraction at an interface between the members.

Although the first retardation film R1, the second retardation film R2, and the third retardation film R3 are adapted to impart a phase difference of a quarter wavelength to at least light of the green wavelength, for example, they are not limited thereto. For example, it is possible to apply retardation films of a broadband type imparting a phase difference of an approximately quarter wavelength to light of each of the red wavelength, the green wavelength, and the blue wavelength as the first retardation film R1, the second retardation film R2, and the third retardation film R3. As such retardation films of a broadband type, it is possible to apply retardation films obtained by attaching quarter-wave plates and half-wave plates in a state where a slow axis of the quarter-wave plates and a slow axis of the half-wave plates form a predetermined angle, for example. It is thus possible to reduce wavelength dependency of the first retardation film R1, the second retardation film R2, and the third retardation film R3.

FIG. 15 is a sectional view illustrating an example of the liquid crystal element 10 illustrated in FIG. 14. The liquid crystal element 10 includes a substrate 11, an alignment film AL11, a liquid crystal layer (first liquid crystal layer) LC1, an alignment film AL12, and a substrate 12.

The substrate 11 and the substrate 12 are transparent substrates that transmit light and are configured of transparent glass plates or transparent synthetic resin plates, for example. Although the substrate 11 is bonded to the third retardation film R3 illustrated in FIG. 3, for example, the substrate 11 may be replaced with the third retardation film R3.

The alignment film AL11 is disposed on an inner surface 11A of the substrate 11. Although the alignment film AL11 is in contact with the substrate 11 in the example illustrated in FIG. 4, another thin film may be interposed between the alignment film AL11 and the substrate 11.

The alignment film AL12 is disposed on an inner surface 12A of the substrate 12. Although the alignment film AL12 is in contact with the substrate 12 in the example illustrated in FIG. 4, another thin film may be interposed between the alignment film AL12 and the substrate 12. The alignment film AL12 faces the alignment film AL11 in the third direction Z.

The alignment film AL11 and the alignment film AL12 are formed of polyimide, for example, and both of them are horizontal alignment films having an alignment restriction force along the X-Y plane.

The liquid crystal layer LC1 is interposed between the alignment film AL11 and the alignment film AL12 and is in contact with the alignment film AL11 and the alignment film AL12. The liquid crystal layer LC1 has a thickness d1 in the third direction Z. The liquid crystal layer LC1 includes a nematic liquid crystal with the same alignment direction in the third direction Z.

In other words, the liquid crystal layer LC1 includes a plurality of liquid crystal structures LMS1. When one liquid crystal structure LMS1 is focused, the liquid crystal structure LMS1 includes a liquid crystal molecule LM11 located on one end side and a liquid crystal molecule LM12 located on the other end side. The liquid crystal molecule LM11 is located near the alignment film AL11, and the liquid crystal molecule LM12 is located near the alignment film AL12. The alignment direction of the liquid crystal molecule LM11 and the alignment direction of the liquid crystal molecule LM12 are substantially the same. In addition, the alignment direction of another liquid crystal molecule LM1 between the liquid crystal molecule LM11 and the liquid crystal molecule LM12 is also substantially the same as the alignment direction of the liquid crystal molecule LM11. Incidentally, the alignment direction of the liquid crystal molecule LM1 here corresponds to a direction of a major axis (a long axis) of the liquid crystal molecule in the X-Y plane.

In addition, the plurality of liquid crystal structures LMS1 that are adjacent to each other in the first direction X have mutually different alignment directions in the liquid crystal layer LC1. Similarly, the plurality of liquid crystal structures LMS1 that are adjacent to each other in the second direction Y also have mutually different alignment directions. The alignment direction of the plurality of liquid crystal molecules LM11 arranged along the alignment film AL11 and the alignment direction of the plurality of liquid crystal molecules LM12 arranged along the alignment film AL12 successively (or linearly) change.

Such a liquid crystal layer LC1 is cured in a state where the alignment directions of the liquid crystal molecules LM1 including the liquid crystal molecules LM11 and the liquid crystal molecules LM12 are fixed. In other words, the alignment directions of the liquid crystal molecules LM1 are not controlled in accordance with an electric field. For this reason, the liquid crystal element 10 does not include any electrode for controlling the alignment.

When refractive anisotropy or a birefringence property (a difference between the refractive index ne of the liquid crystal layer LC1 with respect to abnormal light and the refractive index no with respect to ordinary light) of the liquid crystal layer LC1 is defined as λn, retardation (phase difference) Δn·d1 of the liquid crystal layer LC1 is set to ½ of the specific wavelength λ.

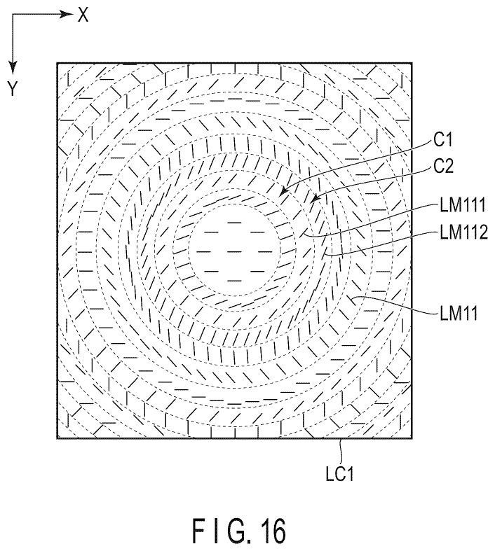

FIG. 16 is a plan view illustrating an example of an alignment pattern in the liquid crystal layer LC1 illustrated in FIG. 15. FIG. 16 illustrates an example of the spatial phase in the X-Y plane of the liquid crystal layer LC1. The spatial phase illustrated here illustrates as an alignment direction of the liquid crystal molecules LM11 near the alignment film AL11 from among the liquid crystal molecules LM1 included in the liquid crystal structure LMS1.

In the concentric circles illustrated by the dashed lines in the drawing, spatial phases are aligned. Alternatively, in an annular area surrounded by two adjacent concentric circles, the alignment direction of the liquid crystal molecules LM11 are the same. However, the liquid crystal molecules LM11 in adjacent annular areas have mutually different alignment directions.

For example, the liquid crystal layer LC1 includes a first annular area C1 and a second annular area C2 in planar view. The second annular area C2 is located outside the first annular area C1. The first annular area C1 is configured of a plurality of first liquid crystal molecules LM111 aligned in the same direction. In addition, the second annular area C2 is configured of a plurality of second liquid crystal molecules LM112 aligned in the same direction. The alignment direction of the first liquid crystal molecules LM111 is different from the alignment direction of the second liquid crystal molecules LM112.

Similarly, the alignment directions of the liquid crystal molecules LM11 aligned in the radial direction from the center area of the concentric circles are different from each other and successively change. In other words, the spatial phases of the liquid crystal layer LC1 differ in the radial direction and successively change in the illustrated X-Y plane.

In a case where the first circularly polarized light is incident on the liquid crystal element 10 with such a configuration, the first circularly polarized light is collected toward the center of the concentric circles, and further, the light transmitted through the liquid crystal element 10 is converted into the second circularly polarized light in the direction opposite to that of the first circularly polarized light.

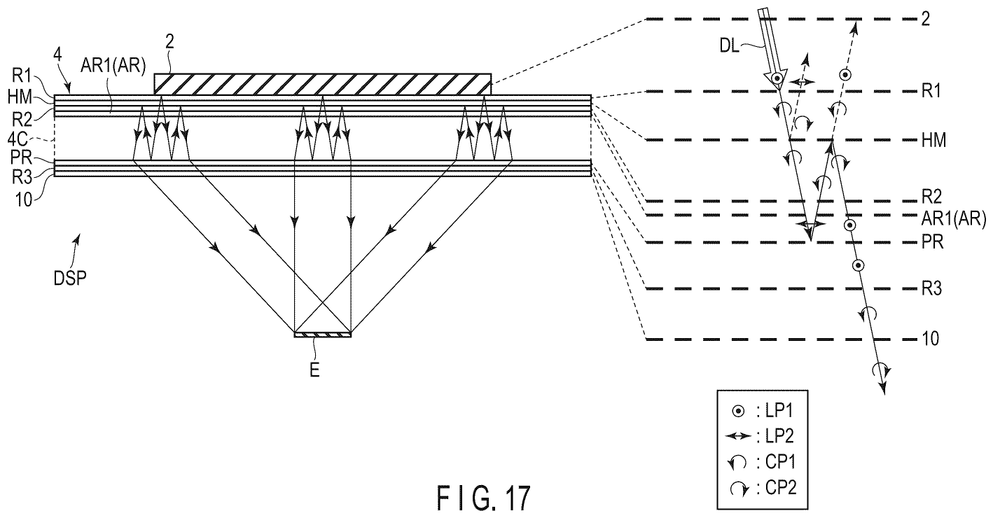

FIG. 17 is a diagram for explaining an optical effect of the display device DSP.

Incidentally, illustration of the illumination device 3 is omitted in FIG. 17. In the following description, display light DL that is incident on the reflective polarizer PR through the second retardation film R2 and display light DL that is incident on the second retardation film R2 through the reflective polarizer PR are assumed to be transmitted through the antireflective film AR. A polarization direction is maintained in the display light DL that is transmitted through the antireflective film AR.

First, the display panel 2 emits display light DL that is first linearly polarized light LP1. The first linearly polarized light LP1 here is linearly polarized light oscillating in a direction perpendicular to the drawing, for example. In addition, the display light DL here is light of a specific wavelength λ. A phase difference of a quarter wavelength is imparted to the display light DL when the display light is transmitted through the first retardation film R1. In this manner, the display light DL is converted into first circularly polarized light CP1 after being transmitted through the first retardation film R1. The first circularly polarized light CP1 here is counterclockwise circularly polarized light, for example.

A part of the first circularly polarized light CP1 transmitted through the first retardation film R1 is transmitted through the transflective layer HM, and the rest of the first circularly polarized light CP1 is reflected by the transflective layer HM. A phase difference of a quarter wavelength is imparted to the first circularly polarized light CP1 transmitted through the transflective layer HM when the first circularly polarized light CP1 is transmitted through the second retardation film R2, and the first circularly polarized light is converted into second linearly polarized light LP2. The second linearly polarized light LP2 here is linearly polarized light that oscillates in a direction that is orthogonal to the first linearly polarized light LP1, that is, a direction that is parallel to the drawing (the sheet).

Incidentally, when the first circularly polarized light CP1 is reflected by the transflective layer HM, the first circularly polarized light CP1 is converted into a second circularly polarized light CP2 in the direction opposite to that of the first circularly polarized light CP1. The second circularly polarized light CP2 here is, for example, clockwise circularly polarized light. The second circularly polarized light CP2 reflected by the transflective layer HM is transmitted through the first retardation film R1, is converted into the second linearly polarized light LP2, and is absorbed at the display panel 2.

The second linearly polarized light LP2 transmitted through the second retardation film R2 is reflected by the reflective polarizer PR. The second linearly polarized light LP2 reflected by the reflective polarizer PR is transmitted through the second retardation film R2 and is then converted into the first circularly polarized light CP1.

A part of the first circularly polarized light CP1 transmitted through the second retardation film R2 is reflected by the transflective layer HM, and the rest of the first circularly polarized light CP1 is transmitted through the transflective layer HM. When the first circularly polarized light CP1 is reflected by the transflective layer HM, the first circularly polarized light CP1 is converted into the second circularly polarized light CP2. The second circularly polarized light CP2 reflected by the transflective layer HM is transmitted through the second retardation film R2 and is then converted into the first linearly polarized light LP1.

Incidentally, the first circularly polarized light CP1 transmitted through the transflective layer HM is transmitted through the first retardation film R1 and is then converted into the first linearly polarized light LP1.

The first linearly polarized light LP1 transmitted through the second retardation film R2 is transmitted through the reflective polarizer PR, is further transmitted through the third retardation film R3, and is then converted into the first circularly polarized light CP1. The first circularly polarized light CP1 transmitted through the third retardation film R3 is converted into the second circularly polarized light CP2 and is also collected on the user's pupil E due to the lens effect in the liquid crystal element 10.

According to such a display device DSP, the optical system 4 includes an optical path passing between the transflective layer HM and the reflective polarizer PR three times. In other words, the optical distance between the transflective layer HM and the reflective polarizer PR is about three times the actual interval between the transflective layer HM and the reflective polarizer PR (or the thickness of the air layer 4C) in the optical system 4. The display panel 2 is installed on a side further inward than the focal point of the liquid crystal element 10 having the lens effect. The user can thus observe an enlarged virtual image.

According to such a first configuration example, it is possible to reduce the thickness in the third direction Z and further to realize weight reduction as compared with an optical system including optical components formed of glass, a resin, or the like.

Incidentally, the first linearly polarized light LP1 described with reference to FIG. 17 may be replaced with the second linearly polarized light LP2, and the first circularly polarized light CP1 may be replaced with the second circularly polarized light CP2.

Similarly to the first embodiment, since the antireflective film AR is provided in the second embodiment as well, undesirable reflected light does thus not occur, and it is possible to suppress degradation in display quality.

### Second Configuration Example

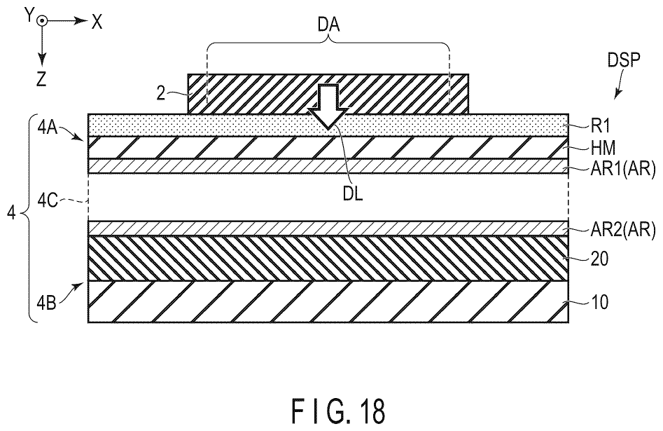

FIG. 18 is a sectional view illustrating a second configuration example of the display device DSP according to the second embodiment. The second configuration example illustrated in FIG. 18 is different from the first configuration example illustrated in FIG. 17 in that the second retardation film R2, the reflective polarizer PR, and the third retardation film R3 are replaced with an optical element 20.

The display device DSP includes a display panel 2 and an optical system 4. Although details of the display panel 2 are omitted here, the display panel 2 is configured to emit display light DL that is linearly polarized light in the display area DA.

A first structure 4A of the optical system 4 includes a first retardation film R1, a transflective layer HM, and an antireflective film AR1. The first retardation film R1 is a quarter-wave plate. The transflective layer HM is adapted to transmit a part of incident light and reflect other light. The antireflective film AR1 can suppress undesirable reflection or refraction at an interface between the transflective layer HM and the air layer.

The first retardation film R1, the transflective layer HM, and the antireflective film AR1 are laminated in this order in the third direction Z. The first retardation film R1 is in contact with the display panel 2. The transflective layer HM is in contact with the first retardation film R1. The antireflective film AR1 is in contact with the transflective layer HM. More specifically, a surface of the transflective layer HM facing the optical element 20 is covered with the antireflective film AR1.

The first retardation film R1 is interposed between the display panel 2 and the transflective layer HM. The transflective layer HM is interposed between the first retardation film R1 and the antireflective film AR1.

A second structure 4B of the optical system 4 includes an antireflective film AR2, an optical element (first optical element) 20, and a liquid crystal element 10. The optical element 20 includes a cholesteric liquid crystal (first cholesteric liquid crystal) as will be described later in detail. The optical element 20 is adapted to reflect the first circularly polarized light toward the transflective layer HM and transmit the second circularly polarized light out of light of a first wavelength. The liquid crystal element 10 imparts a phase difference of a half wavelength to light of a specific wavelength and has a lens effect of collecting the second circularly polarized light. The antireflective film AR2 is similar to the antireflective film AR1.

The liquid crystal element 10, the optical element 20, and the antireflective film AR2 are laminated in this order in the third direction Z. The liquid crystal element 10 is in contact with the optical element 20. The optical element 20 is in contact with the antireflective film AR2. The optical element 20 is interposed between the antireflective film AR2 and the liquid crystal element 10.

The antireflective film AR2 is spaced apart from the antireflective film AR1 and faces the antireflective film AR1 via an air layer 4C in the third direction Z. The antireflective film AR2 is interposed between the transflective layer HM and the optical element 20. More specifically, a surface of the optical element 20 facing the transflective layer HM is covered with the antireflective film AR2.

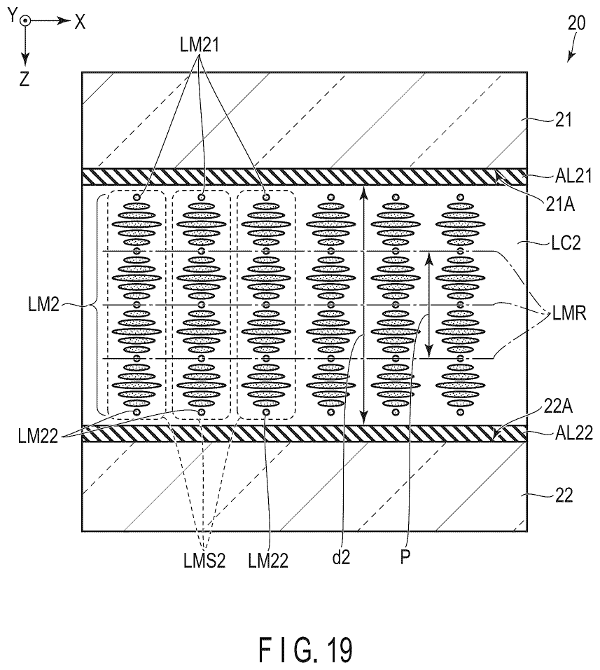

FIG. 19 is a sectional view illustrating an example of the optical element 20 illustrated in FIG. 18. The optical element 20 includes a substrate 21, an alignment film AL21, a liquid crystal layer (second liquid crystal layer) LC2, an alignment film AL22, and a substrate 22.

The substrate 21 and the substrate 22 are transparent substrates that transmit light and are configured of transparent glass plates or transparent synthetic resin plates, for example. Although the substrate 22 is bonded to the liquid crystal element 10 illustrated in FIG. 18, for example, the substrate 22 may be replaced with the substrate 11 of the liquid crystal element 10.

The alignment film AL21 is disposed on an inner surface 21A of the substrate 21. Although the alignment film AL21 is in contact with the substrate 21 in the example illustrated in FIG. 19, another thin film may be interposed between the alignment film AL21 and the substrate 21.

The alignment film AL22 is disposed on an inner surface 22A of the substrate 22. Although the alignment film AL22 is in contact with the substrate 22 in the example illustrated in FIG. 19, another thin film may be interposed between the alignment film AL22 and the substrate 22. The alignment film AL22 faces the alignment film AL21 in the third direction Z.

The alignment film AL21 and the alignment film AL22 are formed of polyimide, for example, and both of them are horizontal alignment films having an alignment restriction force along the X-Y plane.

The liquid crystal layer LC2 is interposed between the alignment film AL21 and the alignment film AL22 and is in contact with the alignment film AL21 and the alignment film AL22. The liquid crystal layer LC2 has a thickness d2 in the third direction Z. The liquid crystal layer LC2 includes a cholesteric liquid crystal. Incidentally, FIG. 19 illustrates liquid crystal molecules directed in an average alignment direction as representatives from among the plurality of liquid crystal molecules located in the X-Y plane as one liquid crystal molecule LM2 for simplification of the drawing.

In other words, the liquid crystal layer LC2 includes a plurality of liquid crystal structures LMS2. When one liquid crystal structure LMS2 is focused, the liquid crystal structure LMS2 includes a liquid crystal molecule LM21 located on one end side and a liquid crystal molecule LM22 located on the other end side. The liquid crystal molecule LM21 is located near the alignment film AL21, and the liquid crystal molecule LM22 is located near the alignment film AL22. The plurality of liquid crystal molecules LM2 including the liquid crystal molecule LM21 and the liquid crystal molecule LM22 are stacked in a spiral shape in the third direction Z while swirling and configure a cholesteric liquid crystal. The alignment direction of the liquid crystal molecule LM21 and the alignment direction of the liquid crystal molecule LM22 are substantially the same. The liquid crystal structure LMS2 has a spiral pitch P. The spiral pitch P indicates one spiral cycle (360 degrees). For example, the thickness d2 of the liquid crystal layer LC2 is equal to or greater than several times the spiral pitch P.

In addition, the plurality of liquid crystal structures LMS2 that are adjacent in the first direction X have mutually the same alignment direction in the liquid crystal layer LC2. Similarly, the plurality of liquid crystal structures LMS2 that are adjacent in the second direction Y also have mutually the same alignment direction. In other words, the alignment directions of the plurality of liquid crystal molecules LM21 aligned along the alignment film AL21 are substantially the same, and also, the alignment directions of the plurality of liquid crystal molecules LM22 aligned along the alignment film AL22 are substantially the same.

The liquid crystal layer LC2 includes a plurality of reflective surfaces LMR as illustrated by the one-dotted chain lines between the alignment film AL21 and the alignment film AL22. The plurality of reflective surfaces LMR are formed along the X-Y plane and are substantially parallel to each other. The reflective surfaces LMR are formed along the X-Y plane. The reflective surfaces LMR reflect a part of circularly polarized light and transmits the rest of the circularly polarized light out of incident light in accordance with the Bragg's rule. The reflective surfaces LMR here correspond to surfaces in which alignment directions of the liquid crystal molecules LM2 are the same or surfaces in which spatial phases are the same (equiphase surfaces).

The liquid crystal structures LMS2 reflect circularly polarized light in the same swirling direction as the swirling direction of the cholesteric liquid crystal out of the light of the first wavelength λ. In a case where the swirling direction of the cholesteric liquid crystal is the clockwise direction, for example, the liquid crystal structures LMS2 reflect clockwise circularly polarized light and transmit counterclockwise circularly polarized light out of the light of the first wavelength λ. Similarly, in a case where the swirling direction of the cholesteric liquid crystal is the counterclockwise direction, the liquid crystal structures LMS2 reflect counterclockwise circularly polarized light and transmit clockwise circularly polarized light out of the light of the first wavelength λ.

Such a liquid crystal layer LC2 is cured in a state where the alignment directions of the liquid crystal molecules LM2 including the liquid crystal molecules LM21 and the liquid crystal molecules LM22 are fixed. In other words, the alignment directions of the liquid crystal molecules LM2 are not controlled in accordance with an electric field. For this reason, the optical element 20 does not include any electrode for controlling the alignment.

If the spiral pitch of the cholesteric liquid crystal is described as P, the refractive index of the liquid crystal molecules with respect to abnormal light is described as ne, and the refractive index of the liquid crystal molecules with respect to ordinary light is described as no (en-ou), a selective reflection band Δλ of the cholesteric liquid crystal with respect to perpendicularly incident light is typically indicated as “no*P to ne*P”. For this reason, in order for the reflective surfaces LMR to efficiently reflect the circularly polarized light of the first wavelength λ, the spiral pitch P and the refractive indexes ne and no are set such that the first wavelength λ is included in the selective reflection wavelength band Δλ.

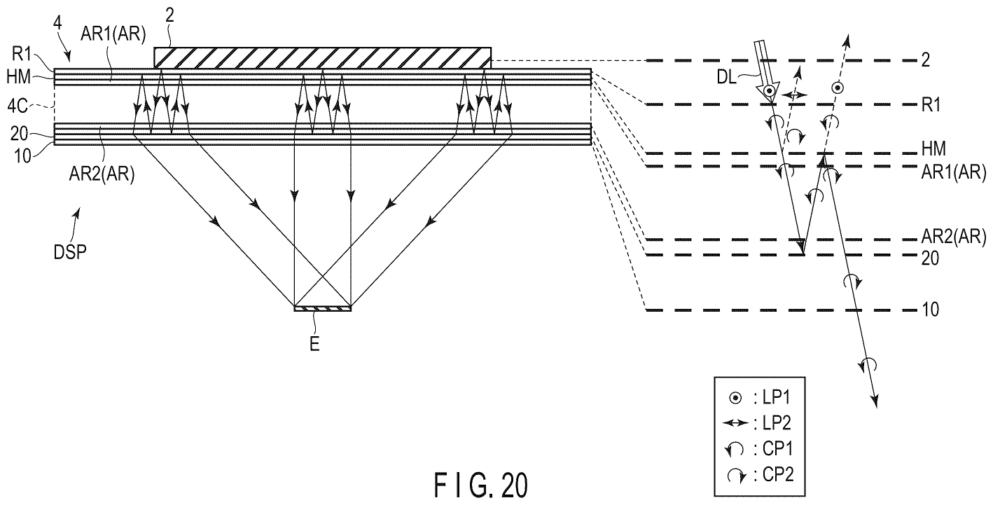

FIG. 20 is a diagram for explaining an optical effect of the display device DSP.

Incidentally, illustration of the illumination device 3 is omitted in FIG. 20. In the following description, display light DL that is incident on the transflective layer HM through the optical element 20 and display light DL that is incident on the optical element 20 through the transflective layer HM are assumed to be transmitted through the antireflective film AR1 and the antireflective film AR2. The polarization direction is maintained in the display light DL transmitted through the antireflective film AR1 and the antireflective film AR2.

First, the display panel 2 emits display light DL that is first linearly polarized light LP1. The display light DL here is light of the first wavelength λ. The display light DL is transmitted through the first retardation film R1 and is then converted into the first circularly polarized light CP1.

A part of the first circularly polarized light CP1 transmitted through the first retardation film R1 is transmitted through the transflective layer HM, and the rest of the first circularly polarized light CP1 is reflected by the transflective layer HM. The first circularly polarized light CP1 transmitted through the transflective layer HM is reflected by the optical element 20.

Incidentally, the first circularly polarized light CP1 is converted into the second circularly polarized light CP2 when the first circularly polarized light CP1 is reflected by the transflective layer HM. The second circularly polarized light CP2 reflected by the transflective layer HM is transmitted through the first retardation film R1, is converted into the second linearly polarized light LP2, and is absorbed at the display panel 2.

A part of the first circularly polarized light CP1 reflected by the optical element 20 is transmitted through the transflective layer HM, and the rest of the first circularly polarized light CP1 is reflected by the transflective layer HM. When the first circularly polarized light CP1 is reflected by the transflective layer HM, the first circularly polarized light CP1 is converted into the second circularly polarized light CP2.

Incidentally, the first circularly polarized light CP1 transmitted through the transflective layer HM is transmitted through the first retardation film R1 and is then converted into the first linearly polarized light LP1.

The second circularly polarized light CP2 reflected by the transflective layer HM is transmitted through the optical element 20. The second circularly polarized light CP2 transmitted through the optical element 20 is converted into the first circularly polarized light CP1 and is collected on the user's pupil E due to the lens effect in the liquid crystal element 10.

Effects that are similar to those of the first configuration example are obtained in such a second configuration example as well. In addition, it is possible to reduce the number of components configuring the optical system 4.

Incidentally, the first linearly polarized light LP1 described with reference to FIG. 11 may be replaced with the second linearly polarized light LP2, and the first circularly polarized light CP1 may be replaced with the second circularly polarized light CP2.

Effects that are similar to those of the first configuration example are obtained in such a second configuration example as well.

### Third Embodiment

In a third embodiment, a display device DSP using an optical system 4 that is different from that in the first embodiment will be described.

Incidentally, the first embodiment will be referred to for components that are similar to those in the first embodiment, and description of these components will be omitted.

### First Configuration Example

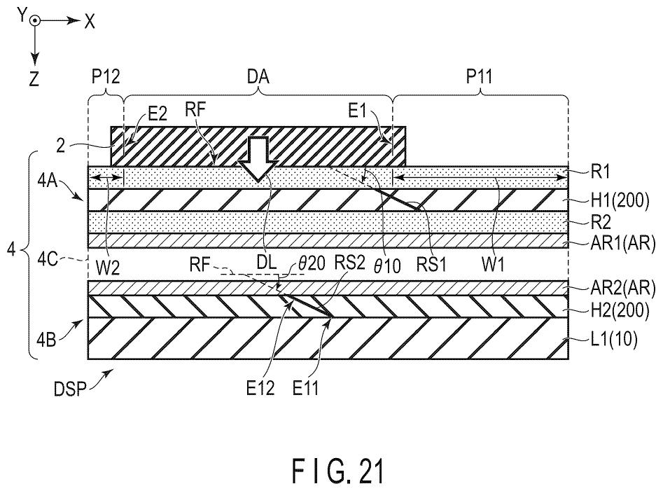

FIG. 21 is a sectional view illustrating a first configuration example of the display device DSP according to the third embodiment.

The display device DSP includes a display panel 2 and an optical system 4. Incidentally, detailed illustration of the display panel 2 is omitted, and illustration of the illumination device is omitted here.

The display panel 2 is formed into a flat plate shape extending in an X-Y plane. The display panel 2 is configured to emit display light DL that is linearly polarized light in a display area DA. For example, the display panel 2 includes a polarizer, and the display light DL that is linearly polarized light is emitted via the polarizer.

The display panel 2 is not limited to a liquid crystal panel not only in the first configuration example described here but also in the other configuration examples of the third embodiment. In a case where the display panel 2 is a display panel including a self-luminous light emitting element, the illumination device 3 is omitted as described above. In addition, the display light DL emitted from the light emitting element is transmitted through the polarizer and is converted into the display light DL that is linearly polarized light in this case.

The optical system 4 includes a first structure 4A and a second structure 4B. The first structure 4A is spaced apart from the second structure 4B. In the example illustrated in FIG. 3, an air layer 4C is provided between the first structure 4A and the second structure 4B. The first structure 4A is interposed between the display panel 2 and the second structure 4B (or between the display panel 2 and the air layer 4C).

The first structure 4A includes a first retardation film R1, a first transflective element H1, a second retardation film R2, and an antireflective film AR1. The first retardation film R1 is a quarter-wave plate and is adapted to impart a phase difference of a quarter wavelength to transmitted light.

The first transflective element H1 includes an optical element 200 including a cholesteric liquid crystal as will be described later in detail. The optical element 200 of the first transflective element H1 is adapted to transmit first circularly polarized light and reflect second circularly polarized light in the direction opposite to that of the first circularly polarized light toward the second structure 4B out of light of specific wavelengths. The optical element 200 of the first transflective element H1 includes a reflective surface RS1 which is illustrated in a simplified manner. When the boundary between the display panel 2 and the first retardation film R1 (or the plane that is parallel to the X-Y plane) is defined as a reference plane RF, an angle θ10 formed between the reflective surface RS1 and the reference plane RF is an acute angle in a clockwise direction from the reference plane RF.

The second retardation film R2 has refractive anisotropy corresponding to the C plate. In other words, when the refractive indexes in directions that are orthogonal to each other within the plane of the second retardation film R2 (within the X-Y plane) are defined as nx and ny, and the refractive index of the second retardation film R2 in the normal direction or the thickness direction (third direction Z) is defined as nz, the refractive index nx and the refractive index ny are substantially equivalent, and the refractive index nz is different from the in-plane refractive index nx (nx=ny≠nz). In other words, the in-plane phase difference of the second retardation film R2 is substantially zero. Incidentally, the refractive anisotropy of the second retardation film R2 may be of a negative type represented as nx=ny>nz or may be of a positive type represented as nx=ny<nz. Such a second retardation film R2 is adapted not to impart a phase difference to light passing through an optical path along the normal line and to impart a phase difference of a half wavelength to light passing through an optical path in an oblique direction with respect to the normal line.

The first retardation film R1, the first transflective element H1, the second retardation film R2, and the antireflective film AR1 extend in a wider range than the display area DA in the X-Y plane. However, it is only necessary for the first retardation film R1 to cover at least the display area DA. In addition, the first retardation film R1, the first transflective element H1, and the second retardation film R2 are laminated in this order in the third direction Z.

The first retardation film R1 is in contact with the display panel 2. The first transflective element H1 is in contact with the first retardation film R1. The second retardation film R2 is in contact with the first transflective element H1. The antireflective film AR1 is in contact with the second retardation film R2.

The first retardation film R1 is interposed between the display panel 2 and the first transflective element H1. The first transflective element H1 is located between the first retardation film R1 and the second retardation film R2. The second retardation film R2 is located between the first transflective element H1 and the antireflective film AR1.

The second structure 4B includes an antireflective film AR2, a second transflective element H2, and a first element L1.

The second transflective element H2 includes an optical element 200 including a cholesteric liquid crystal. The optical element 200 of the second transflective element H2 is adapted to transmit second circularly polarized light and reflect first circularly polarized light toward the first structure 4A out of light of specific wavelengths. The optical element 200 of the second transflective element H2 includes a reflective surface RS2 which is illustrated in a simplified manner. When the boundary between the display panel 2 and the first retardation film R1 (or the plane that is parallel to the X-Y plane) is defined as a reference plane RF, an angle θ20 formed between the reflective surface RS2 and the reference plane RF is an acute angle in a clockwise direction from the reference plane RF.

The first element L1 includes a liquid crystal element 10. The liquid crystal element 10 imparts a phase difference of a half wavelength to light of a specific wavelength and has a lens effect of collecting the second circularly polarized light. Incidentally, although the liquid crystal element 10 has been described as an example of the element having a lens effect of collecting the circularly polarized light here, the element is not limited to the element using a liquid crystal as long as it has an equivalent lens effect.

The antireflective film AR2, the second transflective element H2, and the first element L1 extend in a wider range than the display area DA in the X-Y plane. In addition, the first element L1, the second transflective element H2, and the antireflective film AR2 are laminated in this order in the third direction Z.

The first element L1 is in contact with the second transflective element H2. The second transflective element H2 is in contact with the antireflective film AR2. The antireflective film AR2 is spaced apart from the antireflective film AR1 and faces the antireflective film AR1 in the third direction Z.

In other words, the second transflective element H2 is spaced apart from the first transflective element H1 and the second retardation film R2 with the antireflective film AR1 and the antireflective film AR2 sandwiched therebetween. The second transflective element H2 faces the second retardation film R2 via the first transflective element H1, the second retardation film R2, and the air layer 4C in the third direction Z. The first transflective element H1 and the second transflective element H2 face each other and spaced apart from each other in the third direction Z, and the second retardation film R2, the first transflective element H1, the second retardation film R2, and the air layer 4C are interposed therebetween.

It is also possible to state that the second retardation film R2 is interposed between the first transflective element H1 and the second transflective element H2. The first element L1 faces the second transflective element H2. The second transflective element H2 is interposed between the first element L1 and the antireflective film AR2.

The display area DA includes a first end portion E1 and a second end portion E2 on a side opposite to the first end portion E1. The first retardation film R1, the first transflective element H1, the second retardation film R2, the antireflective film AR1, the antireflective film AR2, the second transflective element H2, and the first element L1 include a first part P11 extending further outward than the first end portion E1 and a second part P12 extending further outward than the second end portion E2. In the example illustrated in FIG. 3, the first part P11 and the second part P12 extend in the first direction X. The width W1 of the first part P11 in the first direction X is greater than the width W2 of the second part P12 in the first direction X (W1>W2).

In FIG. 21, the first part P11 is located on the right side with respect to the display area DA, and the second part P12 is located on the left side with respect to the display area DA. The reflective surface RS2 of the second transflective element H2 includes an end portion E11 on the right side (the side on which the first part P11 is located) in the drawing and an end portion E12 on the left side (the side on which the second part is located) in the drawing. The reflective surface RS2 is inclined such that the end portion E11 is located on the side spaced apart from the display panel 2 and the end portion E12 is located on the side near the display panel 2.

It is desirable that the display panel 2 and the first retardation film R1 be in close contact with each other without intervention of any air layer. In addition, it is desirable that the first retardation film R1, the first transflective element H1, the second retardation film R2, and the antireflective film AR1 configuring the first structure 4A be in close contact with each other without intervention of an air layer. Moreover, it is desirable that the antireflective film AR2, the second transflective element H2, and the first element L1 configuring the second structure 4B be in close contact with each other without intervention of an air layer. It is thus possible to suppress undesirable reflection or refraction at an interface between the members.

Incidentally, although the first retardation film R1 is adapted to impart a phase difference of a quarter wavelength to at least light of the green wavelength, for example, the first retardation film R1 is not limited thereto. For example, it is possible to apply a retardation film of a broadband type imparting a phase difference of an approximately quarter wavelength to light of each of the red wavelength, the green wavelength, and the blue wavelength as the first retardation film R1. As such retardation films of a broadband type, it is possible to apply retardation films obtained by attaching quarter-wave plates and half-wave plates in a state where a slow axis of the quarter-wave plates and a slow axis of the half-wave plates form a predetermined angle, for example. It is thus possible to reduce wavelength dependency of the first retardation film R1.

As the liquid crystal element 10, the liquid crystal element 10 including the liquid crystal layer LC1 of a nematic liquid crystal described above in FIGS. 15 and 16 may be used.

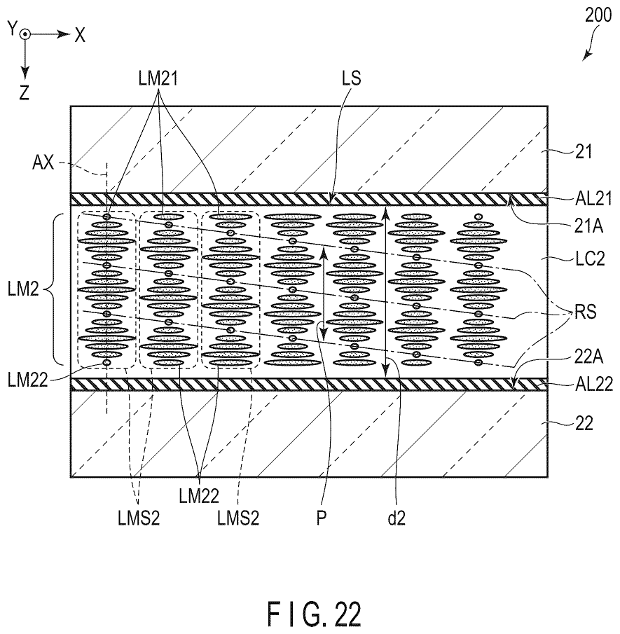

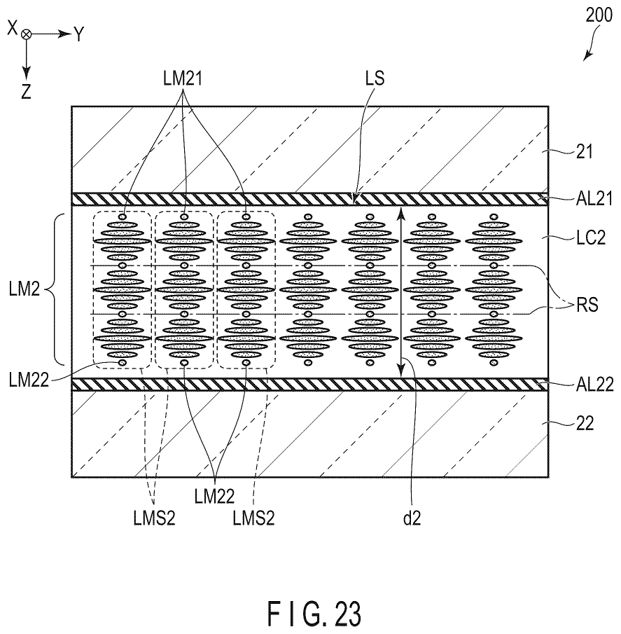

FIGS. 22 and 23 are sectional views illustrating an example of the optical element 200 illustrated in FIG. 21. FIG. 22 illustrates an X-Z section defined by the first direction X and the third direction Z, and FIG. 23 illustrates a Y-Z section defined by the second direction Y and the third direction Z. Hereinafter, description will be given primarily with reference to FIG. 22. In addition, in regard to description of the optical element 200, parts similar to those of the optical element 20 illustrated in FIG. 19 will be referred to, and details thereof will be omitted.

The liquid crystal layer LC2 of the optical element 200 includes a cholesteric liquid crystal. In the liquid crystal layer LC2, a spiral axis AX of the liquid crystal structures LMS2 is parallel to the normal direction of the liquid crystal layer LC2, that is, the third direction Z.

As shown in FIG. 22, the plurality of liquid crystal structures LMS2 that are adjacent to each other in the first direction X have mutually different alignment directions in the liquid crystal layer LC2. The alignment direction of the plurality of liquid crystal molecules LM21 arranged along the alignment film AL21 and the alignment direction of the plurality of liquid crystal molecules LM22 arranged along the alignment film AL22 successively change.

Incidentally, the plurality of liquid crystal structures LMS2 that are adjacent to each other in the second direction Y have mutually the same alignment direction in the liquid crystal layer LC2 as shown in FIG. 23. In other words, the alignment directions of the plurality of liquid crystal molecules LM21 aligned along the alignment film AL21 are substantially the same, and also, the alignment directions of the plurality of liquid crystal molecules LM22 aligned along the alignment film AL22 are substantially the same.

The liquid crystal layer LC2 includes a plurality of reflective surfaces RS as illustrated by the one-dotted chain lines between the alignment film AL21 and the alignment film AL22. The plurality of reflective surfaces RS are substantially parallel to each other. The reflective surfaces RS reflect a part of circularly polarized light and transmit the rest of circularly polarized light out of incident light in accordance with the Bragg's rule. The reflective surfaces RS here correspond to surfaces in which the alignment directions of the liquid crystal molecules LM2 are the same or surfaces in which spatial phases are the same (equiphase surfaces).

In the X-Z section illustrated in FIG. 22, the reflective surfaces RS are inclined with respect to a main surface LS of the liquid crystal layer LC2. The main surface LS here is a boundary between the liquid crystal layer LC2 and the alignment film AL21, for example, is a surface that is parallel to the reference plane RF illustrated in FIG. 21, and is a surface that is parallel to the X-Y plane.

In addition, the reflective surfaces RS are parallel to the main surface LS of the liquid crystal layer LC2 in the Y-Z section illustrated in FIG. 23. In other words, each of the plurality of reflective surfaces RS has a substantially planar shape extending in a specific direction as shown in FIGS. 22 and 23.

Each of the optical element 200 of the first transflective element H1 illustrated in FIG. 21 and the optical element 200 of the second transflective element H2 has the liquid crystal layer LC2 including the liquid crystal structures LMS2 corresponding to the cholesteric liquid crystal illustrated in FIG. 22. Each of the reflective surface RS1 of the first transflective element H1 and the reflective surface RS2 of the second transflective element H2 illustrated in FIG. 21 corresponds to the reflective surface RS illustrated in FIG. 22 and is inclined with respect to the main surface LS of the liquid crystal layer LC2.

In the first transflective element H1 and the second transflective element H2, each liquid crystal structure (cholesteric liquid crystal) LMS2 has an equivalent spiral pitch to reflect circularly polarized light of the same wavelength. In addition, in order for the first transflective element H1 to reflect the second circularly polarized light and for the second transflective element H2 to reflect the first circularly polarized light, each of the liquid crystal structures (cholesteric liquid crystal) LMS2 in each of the first transflective element H1 and the second transflective element H2 swirls in the mutually opposite directions.

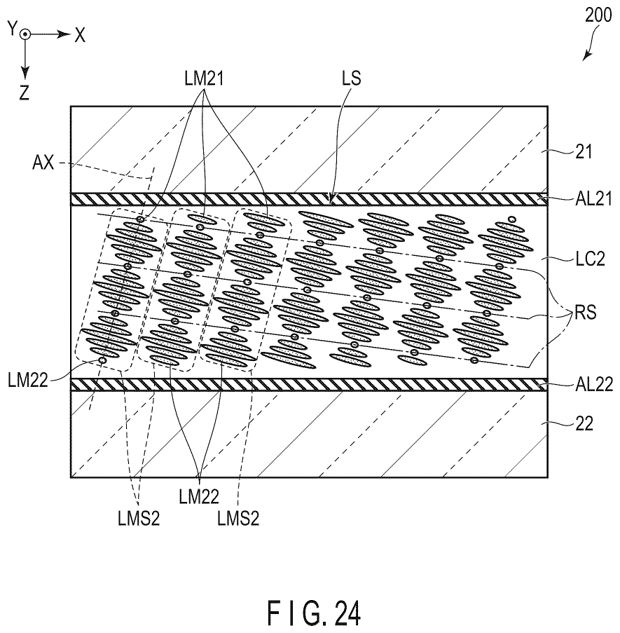

FIG. 24 is a sectional view illustrating a modified example of the optical element 200 illustrated in FIG. 21. FIG. 24 illustrates an X-Z section. The modified example illustrated in FIG. 24 is different from the examples illustrated in FIG. 22 and the like in that the spiral axis AX of the liquid crystal structures LMS2 is inclined with respect to the normal direction (third direction Z) of the liquid crystal layer LC2.

The plurality of liquid crystal structures LMS2 that are adjacent to each other in the first direction X have mutually different alignment directions in the liquid crystal layer LC2. The alignment direction of the plurality of liquid crystal molecules LM21 arranged along the alignment film AL21 and the alignment direction of the plurality of liquid crystal molecules LM22 arranged along the alignment film AL22 successively change.

The liquid crystal layer LC2 includes a plurality of reflective surfaces RS as illustrated by the one-dotted chain lines between the alignment film AL21 and the alignment film AL22. The plurality of reflective surfaces RS are substantially parallel to each other. The reflective surfaces RS reflect a part of circularly polarized light and transmit the rest of circularly polarized light out of incident light in accordance with the Bragg's rule. In the X-Z section illustrated in FIG. 24, the reflective surfaces RS are inclined with respect to the main surface LS of the liquid crystal layer LC2. Incidentally, the reflective surfaces RS are parallel to the main surface LS similarly to the example illustrated in FIG. 23 in the Y-Z section.

It is possible to realize optical properties that are similar to those of the examples illustrated in FIGS. 22 and 23 even in such a modified example.

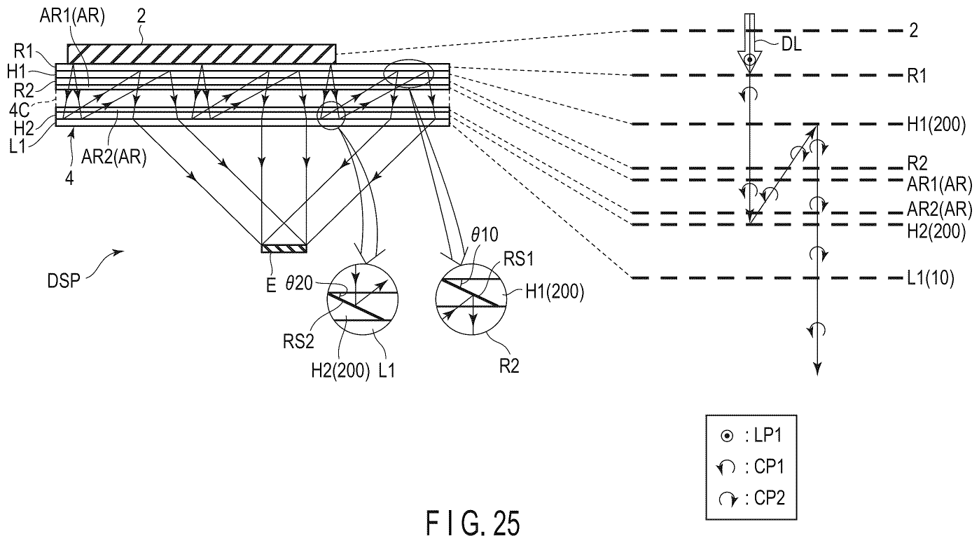

FIG. 25 is a diagram for explaining an optical effect of the display device DSP according to the third embodiment; Incidentally, illustration of the illumination device 3 is omitted in FIG. 25. In the following description, display light DL that is incident on the second transflective element H2 (optical element 200) through the second retardation film R2 and display light DL that is incident on the second retardation film R2 through the second transflective element H2 (optical element 200) are assumed to be transmitted through the antireflective film AR1 and the antireflective film AR2. The polarization direction is maintained in the display light DL transmitted through the antireflective film AR1 and the antireflective film AR2.

First, the display panel 2 emits display light DL that is first linearly polarized light LP1. The first linearly polarized light LP1 here is linearly polarized light oscillating in a direction perpendicular to the drawing, for example. A phase difference of a quarter wavelength is imparted to the display light DL when the display light is transmitted through the first retardation film R1. In this manner, the display light DL is converted into the first circularly polarized light CP1 when the display light DL is transmitted through the first retardation film R1. The first circularly polarized light CP1 here is counterclockwise circularly polarized light, for example.

The first circularly polarized light CP1 transmitted through the first retardation film R1 is transmitted through the first transflective element H1 (optical element 200).

The first circularly polarized light CP1 transmitted through the first transflective element H1 is transmitted substantially perpendicularly through the second retardation film R2. As described above with reference to FIG. 3, the in-plane phase difference of the second retardation film R2 is zero, and the polarization state of the light that is transmitted substantially perpendicularly through the second retardation film R2 is thus maintained. In other words, the light that is transmitted substantially perpendicular through the second retardation film R2 is the first circularly polarized light CP1.

The first circularly polarized light CP1 transmitted through the second retardation film R2 is reflected by the second transflective element H2 (optical element 200). At this time, the first circularly polarized light CP1 that is incident substantially perpendicularly on the second transflective element H2 is reflected in an oblique direction by the reflective surface RS2 as shown in FIG. 25 in an enlarged manner. The angle of reflection of the first circularly polarized light CP1 is controlled by an angle of inclination θ20 of the reflective surface RS2. Incidentally, the polarization state is maintained when the first circularly polarized light CP1 is reflected by the reflective surface RS2. In other words, the light reflected by the reflective surface RS2 is the first circularly polarized light CP1.

The first circularly polarized light CP1 reflected by the second transflective element H2 is transmitted obliquely through the second retardation film R2. As described above with reference to FIG. 21, the second retardation film R2 imparts a phase difference of a half wavelength to the light transmitted in the oblique direction. For this reason, the light transmitted through the second retardation film R2 in the oblique direction is converted into the second circularly polarized light CP2 in the direction opposite to that of the first circularly polarized light CP1. The second circularly polarized light CP2 here is, for example, clockwise circularly polarized light.

The second circularly polarized light CP2 transmitted through the second retardation film R2 is reflected by the first transflective element H1 (optical element 200). At this time, the second circularly polarized light CP2 that is incident on the first transflective element H1 in the oblique direction is reflected in the normal direction of the first transflective element H1 by the reflective surface RS1 as shown in FIG. 25 in an enlarged manner. The angle of reflection of the second circularly polarized light CP2 is controlled by an angle of inclination θ10 of the reflective surface RS1. Incidentally, the polarization state is maintained when the second circularly polarized light CP2 is reflected by the reflective surface RS1. In other words, the light reflected by the reflective surface RS1 is the second circularly polarized light CP2.

The second circularly polarized light CP2 reflected by the first transflective element H1 is transmitted substantially perpendicularly through the second retardation film R2, and the polarization state is maintained. The second circularly polarized light CP2 transmitted through the second retardation film R2 is transmitted through the second transflective element H2. The second circularly polarized light CP2 transmitted through the second transflective element H2 is converted into the first circularly polarized light CP1 and is collected on the user's pupil E due to the lens effect in the first element L1 (liquid crystal element 10).

According to such a display device DSP, the optical system 4 includes an optical path passing between the first transflective element H1 and the second transflective element H2 three times. In other words, the optical distance between the first transflective element H1 and the second transflective element H2 is about three times the actual interval between the first transflective element H1 and the second transflective element H2 (or the thickness of the air layer 4C) in the optical system 4. The display panel 2 is installed on a side further inward than the focal point of the liquid crystal element 10 having the lens effect. The user can thus observe an enlarged virtual image.

According to such a first configuration example, it is possible to collect substantially 100% of display light DL emitted from the display panel 2 on the pupil E if absorption by each member configuring the display device DSP and reflection between the members are ignored, and it is thus possible to improve utilization efficiency of the light.

In addition, it is possible to reduce the thickness in the third direction Z and further to realize a lighter weight as compared with an optical system including optical components formed of glass, a resin, and the like.

Incidentally, the first circularly polarized light CP1 described with reference to FIG. 25 may be replaced with the second circularly polarized light CP2.

### Second Configuration Example

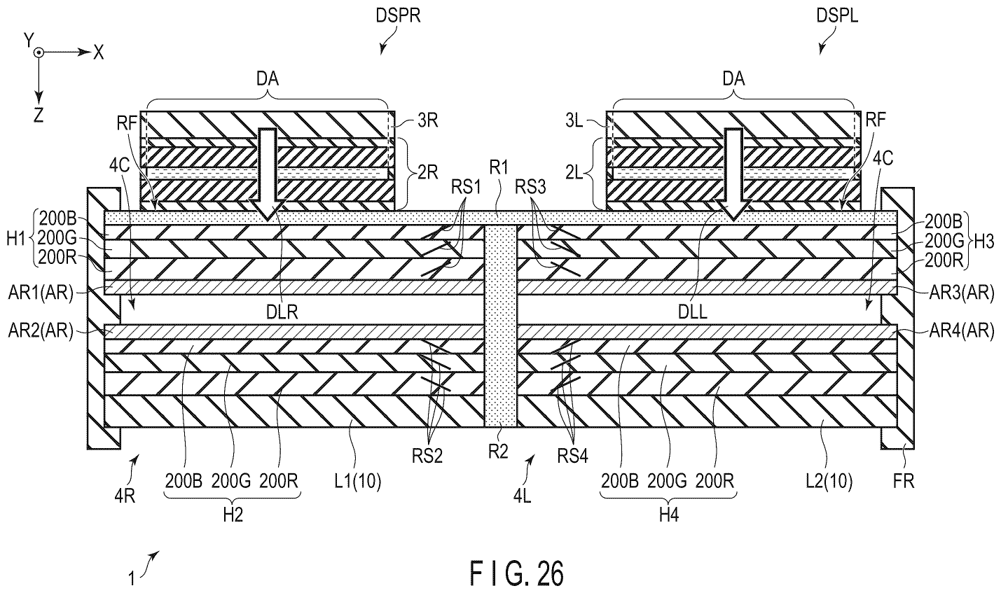

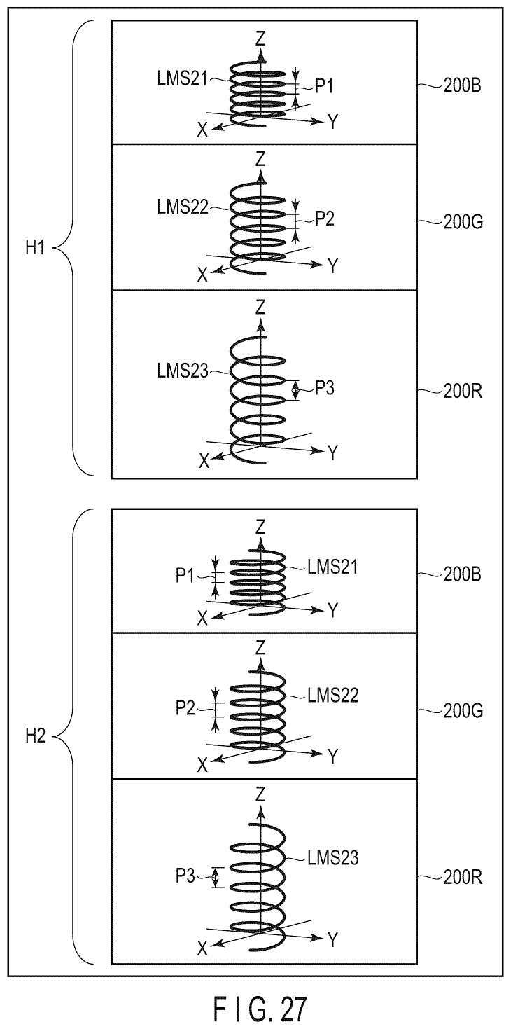

FIG. 26 is a sectional view illustrating a second configuration example of a head-mounted display 1 according to the third embodiment; The head-mounted display 1 illustrated in FIG. 26 includes a display device DSPL for a left eye, a display device DSPR for a right eye, and a frame FR holding the display device DSPR and the display device DSPL. FIG. 27 is a diagram for explaining a first optical element 200B, a second optical element 200G, and a third optical element 200R illustrated in FIG. 26.

The display device DSPL for the left eye includes a display panel 2L and an illumination device 3L for the left eye and is disposed on the right side in the drawing. The display device DSPR for the right eye includes a display panel 2R and an illumination device 3R for the right eye and is disposed on the left side in the drawing.

The display panel 2R is configured to emit display light DLR that is linearly polarized light in a display area DA. The display panel 2L is configured to emit display light DLL that is linearly polarized light in the display area DA.

The illumination device 3R and the illumination device 3L correspond to the illumination device 3 described above with reference to FIG. 5 though not described here in detail. Each of the illumination device 3R and the illumination device 3L includes a first light emitting element LDB that emits blue laser light of a center wavelength λb, a second light emitting element LDG that emits green laser light of a center wavelength λg, and a third light emitting element LDR that emits red laser light of a center wavelength λr.

Each of the display panel 2R and the display panel 2L correspond to the display panel 2 described above with reference to FIG. 3.

An optical system 4R corresponding to the display device DSPR includes a first retardation film R1, a first transflective element H1, an antireflective film AR1, an antireflective film AR2, a second transflective element H2, and a first element L1. Incidentally, the first retardation film R1 is disposed over the display device DSPR and the display device DSPL.

The first transflective element H1 is interposed between the first retardation film R1 and the antireflective film AR1. The first transflective element H1 includes a first optical element 200B, a second optical element 200G, and a third optical element 200R. Each of the first optical element 200B, the second optical element 200G, and the third optical element 200R includes a reflective surface RS1. An angle formed between the reflective surface RS1 and a reference plane RF (X-Y plane) is an acute angle in the counterclockwise direction from the reference plane RF.

The first optical element 200B, the second optical element 200G, and the third optical element 200R are laminated in the third direction Z.

Incidentally, the lamination order of the first optical element 200B, the second optical element 200G, and the third optical element 200R is not limited to the illustrated example. The first optical element 200B, the second optical element 200G, and the third optical element 200R are equivalent to the optical element 200 described above with reference to FIGS. 22 to 24 and the like.

However, the first optical element 200B is configured to reflect second circularly polarized light of the blue wavelength (first wavelength) λb and transmits first circularly polarized light of the blue wavelength λb as shown in FIG. 27. In other words, a first spiral pitch P1 of liquid crystal structures (first cholesteric liquid crystals) LMS21 included in the first optical element 200B is optimized to correspond to the center wavelength λb of the blue laser light emitted from the first light emitting element LDB of the illumination device 3.

In addition, the second optical element 200G is configured to reflect second circularly polarized light of the green wavelength (second wavelength) λg and transmits first circularly polarized light of the green wavelength λg, as shown in FIG. 27. In other words, a second spiral pitch P2 of liquid crystal structures (second cholesteric liquid crystals) LMS22 included in the second optical element 200G is optimized to correspond to the center wavelength λg of the green laser light emitted from the second light emitting element LDG of the illumination device 3. For this reason, the second spiral pitch P2 of the second optical element 200G is greater than the first spiral pitch P1 of the first optical element 200B.

Moreover, the third optical element 200R is configured to reflect second circularly polarized light of the red wavelength (third wavelength) λr and transmit first circularly polarized light of the red wavelength λr as shown in FIG. 27. In other words, a third spiral pitch P3 of liquid crystal structures (third cholesteric liquid crystals) LMS23 included in the third optical element 200R is optimized to correspond to the center wavelength λr of the red laser light emitted from the third light emitting element LDR of the illumination device 3. For this reason, the third spiral pitch P3 of the third optical element 200R is greater than the second spiral pitch P2 of the second optical element 200G.

Incidentally, all of the liquid crystal structures (first cholesteric liquid crystals) LMS21, the liquid crystal structures (second cholesteric liquid crystals) LMS22, and the liquid crystal structures (third cholesteric liquid crystals) LMS23 in the first transflective element H1 swirl in the same direction, and all of them are configured to reflect clockwise second circularly polarized light.

The second transflective element H2 is in contact with the antireflective film AR2. The second transflective element H2 includes a first optical element 200B, a second optical element 200G, and a third optical element 200R similarly to the first transflective element H1. Each of the first optical element 200B, the second optical element 200G, and the third optical element 200R has a reflective surface RS2. An angle formed between the reflective surface RS2 and a reference plane RF (X-Y plane) is an acute angle in the counterclockwise direction from the reference plane. In other words, the direction of the reflective surface RS2 is the same as the direction of the reflective surface RS1.

The first optical element 200B, the second optical element 200G, and the third optical element 200R are laminated in the third direction Z even in the second transflective element H2. Incidentally, although the lamination order of the first optical element 200B, the second optical element 200G, and the third optical element 200R is not limited to that in the illustrated example, the lamination order in the first transflective element H1 is the same as the lamination order in the second transflective element H2.

The first optical element 200B, the second optical element 200G, and the third optical element 200R in the second transflective element H2 are equivalent to the first optical element 200B, the second optical element 200G, and the third optical element 200R in the first transflective element H1, respectively.

However, the first optical element 200B is configured to reflect first circularly polarized light of the blue wavelength (first wavelength) λb and transmit second circularly polarized light of the blue wavelength λb in the second transflective element H2. In other words, the first optical element 200B of the second transflective element H2 includes liquid crystal structures (first cholesteric liquid crystals) LMS21 swirling in a second swirling direction that is opposite to the first swirling direction. The swirling direction of the liquid crystal structures LMS21 in the second transflective element H2 is opposite to the swirling direction of the liquid crystal structures LMS21 in the first transflective element H1.

The first spiral pitch P1 of the liquid crystal structures LMS21 is optimized to correspond to the center wavelength λb of the blue laser light emitted from the first light emitting element LDB of the illumination device 3. The first spiral pitch P1 of the liquid crystal structures LMS21 of the second transflective element H2 is equivalent to the first spiral pitch P1 of the liquid crystal structures LMS21 of the first transflective element H1.

The second optical element 200G is configured to reflect first circularly polarized light of the green wavelength (second wavelength) λg and transmit second circularly polarized light of the green wavelength λg. In other words, the second optical element 200G of the second transflective element H2 includes liquid crystal structures (second cholesteric liquid crystals) LMS22 swirling in the second swirling direction. The swirling direction of the liquid crystal structures LMS22 in the second transflective element H2 is opposite to the swirling direction of the liquid crystal structures LMS22 in the first transflective element H1.

The second spiral pitch P2 of the liquid crystal structures LMS22 is optimized to correspond to the center wavelength λg of the green laser light emitted from the second light emitting element LDG of the illumination device 3. For this reason, the second spiral pitch P2 of the second optical element 200G is greater than the first spiral pitch P1 of the first optical element 200B. The second spiral pitch P2 of the liquid crystal structures LMS22 of the second transflective element H2 is equivalent to the second spiral pitch P2 of the liquid crystal structures LMS22 of the first transflective element H1.

The third optical element 200R is configured to reflect first circularly polarized light of the red wavelength (third wavelength) λr and transmit second circularly polarized light of the red wavelength λr. In other words, the third optical element 200R of the second transflective element H2 includes liquid crystal structures (third cholesteric liquid crystal) LMS23 swirling in the second swirling direction. The swirling direction of the liquid crystal structures LMS23 in the second transflective element H2 is opposite to the swirling direction of the liquid crystal structures LMS23 in the first transflective element H1.

The third spiral pitch P3 of the liquid crystal structures LMS23 is optimized to correspond to the center wavelength λr of the red laser light emitted from the third light emitting element LDR of the illumination device 3. For this reason, the third spiral pitch P3 of the third optical element 200R is greater than the second spiral pitch P2 of the second optical element 200G. The third spiral pitch P3 of the liquid crystal structures LMS23 of the second transflective element H2 is equivalent to the third spiral pitch P3 of the liquid crystal structures LMS23 of the first transflective element H1.

Incidentally, all of the first cholesteric liquid crystals LMS21, the second cholesteric liquid crystals LMS22, and the third cholesteric liquid crystals LMS23 in the second transflective element H2 swirl in the same direction, and all of them are configured to reflect counterclockwise first circularly polarized light.

In this manner, when the wavelength λb of the circularly polarized light reflected by the first optical element 200B is defined as the first wavelength in the first transflective element H1 and the second transflective element H2, the second optical element 200G is configured to reflect circularly polarized light of the second wavelength λg that is longer than the first wavelength λb, and the third optical element 200R is configured to reflect circularly polarized light of the third wavelength λr that is longer than the second wavelength λg.

The first element L1 includes a liquid crystal element 10. The liquid crystal element is equivalent to the liquid crystal element 10 described above with reference to FIGS. 15 and 16.

The liquid crystal element 10 imparts a phase difference of a half wavelength to light of the green wavelength (second wavelength) λg, for example, and has a lens effect of collecting at least second circularly polarized light of the green wavelength λg. In other words, retardation of the liquid crystal element 10 is optimized to correspond to the center wavelength λg of the green laser light emitted from the second light emitting element LDG of the illumination device 3.

Incidentally, the liquid crystal element 10 applied in the present embodiment also has a function of collecting second circularly polarized light of not only the green wavelength λg but also the blue wavelength λb and the red wavelength λr.

The optical system 4L in the display device DSPL is configured similarly to the optical system 4R and includes a first retardation film R1, a third transflective element H3, an antireflective film AR3, an antireflective film AR4, a fourth transflective element H4, and a second element L2.

The third transflective element H3 is interposed between the first retardation film R1 and the antireflective film AR3 in the third direction Z and is adjacent to the first transflective element H1 in the first direction X. The fourth transflective element H4 is spaced apart from the antireflective film AR3 in the third direction Z and is adjacent to the second transflective element H2 in the first direction X.

The second element L2 is in contact with the fourth transflective element H4 in the third direction Z and is adjacent to the first element L1 in the first direction X.

Each of the third transflective element H3 and the fourth transflective element H4 includes a first optical element 200B, a second optical element 200G, and a third optical element 200R similarly to the first transflective element H1.

The first optical element 200B, the second optical element 200G, and the third optical element 200R in the third transflective element H3 are equivalent to the first optical element 200B, the second optical element 200G, and the third optical element 200R in the first transflective element H1, respectively, and are configured to transmit first circularly polarized light and reflect second circularly polarized light. However, the first transflective element H1 and the third transflective element H3 have reflective surfaces in mutually different directions.

In other words, each of the first optical element 200B, the second optical element 200G, and the third optical element 200R in the third transflective element H3 has a reflective surface RS3. An angle formed between the reflective surface RS3 and the reference plane RF (X-Y plane) is an acute angle in the clockwise direction from the reference plane RF. In other words, the reflective surface RS3 and the reflective surface RS1 have mutually different directions.

The first optical element 200B, the second optical element 200G, and the third optical element 200R in the fourth transflective element H4 are equivalent to the first optical element 200B, the second optical element 200G, and the third optical element 200R in the second transflective element H2, respectively, and are configured to reflect first circularly polarized light and transmit second circularly polarized light. However, the second transflective element H2 and the fourth transflective element H4 have reflective surfaces in mutually different directions.

In other words, each of the first optical element 200B, the second optical element 200G, and the third optical element 200R in the fourth transflective element H4 has a reflective surface RS4. An angle formed between the reflective surface RS4 and a reference plane RF (X-Y plane) is an acute angle in the counterclockwise direction from the reference plane RF. In other words, the reflective surface RS4 and the reflective surface RS2 have mutually different directions. In addition, the direction of the reflective surface RS4 is similar to the direction of the reflective surface RS3.

The second element L2 includes the liquid crystal element 10 similarly to the first element L1. However, the position at which light is collected by the first element L1 and the position at which light is collected by the second element L2 are different from each other.

The second retardation film R2 is disposed over a part between the first transflective element H1 and the third transflective element H3 and a part between the second transflective element H2 and the fourth transflective element H4. The second retardation film R2 sections a part between the air layer 4C on the right side in the drawing and the air layer 4C on the left side in the drawing.

The second retardation film R2 is formed into a plate shape extending along the Y-Z plane and has a thickness in the first direction X. In other words, the second retardation film R2 has substantially equivalent refractive indexes in mutually orthogonal directions in the Y-Z plane, and the refractive index in the first direction X has refractive anisotropy that is different from that of the in-plane refractive index. Such a second retardation film R2 is adapted not to impart a phase difference to light passing through an optical path that is parallel to the first direction X and to impart a phase difference of a half wavelength to light passing through an optical path in an oblique direction with respect to the first direction X.

The first transflective element H1 and the second transflective element H2 face each other via the antireflective film AR1, the antireflective film AR2, and the air layer 4C in the third direction Z. The antireflective film AR1 and the antireflective film AR2 face each other via the air layer 4C.

The third transflective element H3 and the fourth transflective element H4 face each other via the antireflective film AR3, the antireflective film AR4, and the air layer 4C in the third direction Z. The antireflective film AR3 and the antireflective film AR4 face each other via the air layer 4C.

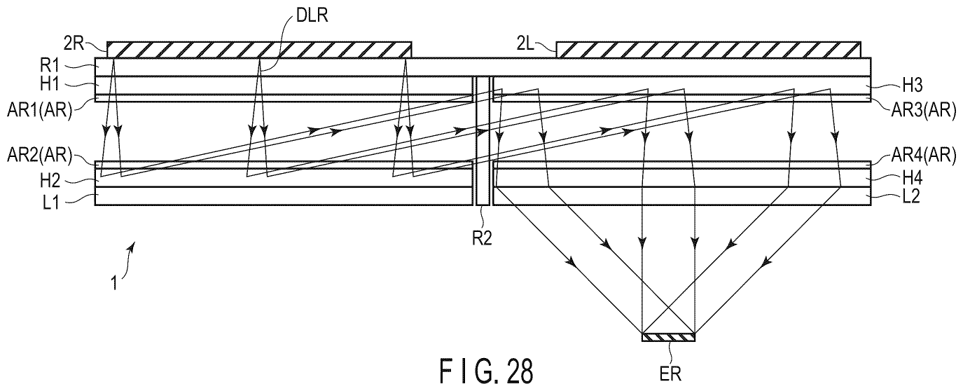

FIG. 28 is a diagram for explaining an optical effect of the head-mounted display 1 illustrated in FIG. 26. Here, an optical path through which display light DLR from the display panel 2R for the right eye reaches the right eye ER will be focused and described. Incidentally, a polarization state of light is as shown in FIG. 25, and illustration thereof in FIG. 28 is omitted.

In the following description in FIG. 28, display light DLR that is incident on the second transflective element H2 through the first transflective element H1, display light DLR that is incident on the third transflective element H3 through the second transflective element H2, and display light DLR that is incident on the fourth transflective element H4 through the third transflective element H3 are assumed to be transmitted through the antireflective film AR1, the antireflective film AR2, and the antireflective film AR3, and the antireflective film AR4. The polarization direction is maintained in the display light DLR transmitted through the antireflective film AR1, the antireflective film AR2, the antireflective film AR3, and the antireflective film AR4.

First, the display panel 2R emits the display light DLR. The display light DLR is first linearly polarized light LP1. The display light DLR is converted into first circularly polarized light CP1 when the display light DLR is transmitted through the first retardation film R1. The first circularly polarized light CP1 transmitted through the first retardation film R1 is transmitted through the first transflective element H1 (optical elements 200B, 200G, and 200R).

The first circularly polarized light CP1 transmitted through the first transflective element H1 is reflected by the second transflective element H2 (optical elements 200B, 200G, and 200R). The second transflective element H2 reflects the first circularly polarized light CP1 toward the third transflective element H3 overlapping the display panel 2L.

The first circularly polarized light CP1 reflected by the second transflective element H2 is converted into second circularly polarized light CP2 when the first circularly polarized light CP1 is transmitted obliquely through the second retardation film R2. The second circularly polarized light CP2 transmitted through the second retardation film R2 is reflected by the third transflective element H3 (optical elements 200B, 200G, and 200R). The third transflective element H3 reflects the second circularly polarized light CP2 toward the fourth transflective element H4 overlapping the display panel 2L.

The second circularly polarized light CP2 reflected by the third transflective element H3 is transmitted through the fourth transflective element H4, is then converted into the first circularly polarized light CP1 by the second element L2 (liquid crystal element 10), and is collected on the user's right eye ER due to the lens effect.

The display light DLL from the display panel 2L for the left eye also reaches the left eye EL in a similar manner.

Effects that are similar to those of the first configuration example are obtained even in such a second configuration example.

### Third Configuration Example

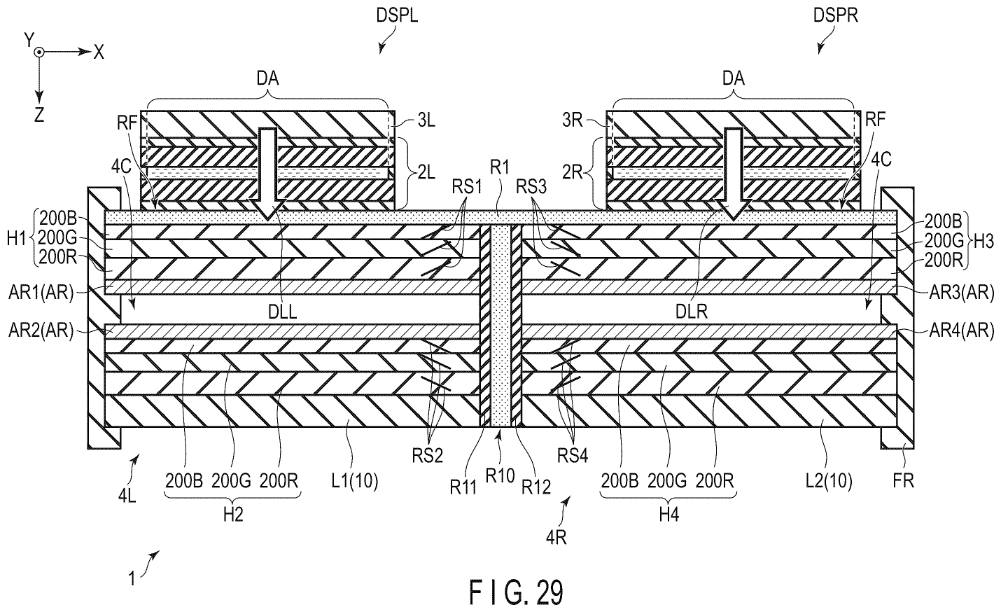

FIG. 29 is a sectional view illustrating a third configuration example of the head-mounted display 1. The third configuration example illustrated in FIG. 29 is different from the second configuration example illustrated in FIG. 26 in that the second retardation film R2 is replaced with a reflecting member R10.

The display device DSPL for the left eye includes a display panel 2L and an illumination device 3L for the left eye and is disposed on the left side in the drawing. The display device DSPR for the right eye includes a display panel 2R and an illumination device 3R for the right eye and is disposed on the right side in the drawing.

The reflecting member R10 is disposed over a part between the first transflective element H1 and the third transflective element H3 and a part between the second transflective element H2 and the fourth transflective element H4. The reflecting member R10 includes a first reflective surface R11 facing the first transflective element H1 and the second transflective element H2 and a second reflective surface R12 facing the third transflective element H3 and the fourth transflective element H4. The first reflective surface R11 and the second reflective surface R12 extend along the Y-Z plane. The reflecting member R10 sections a part between the air layer 4C on the right side in the drawing and the air layer 4C on the left side in the drawing.

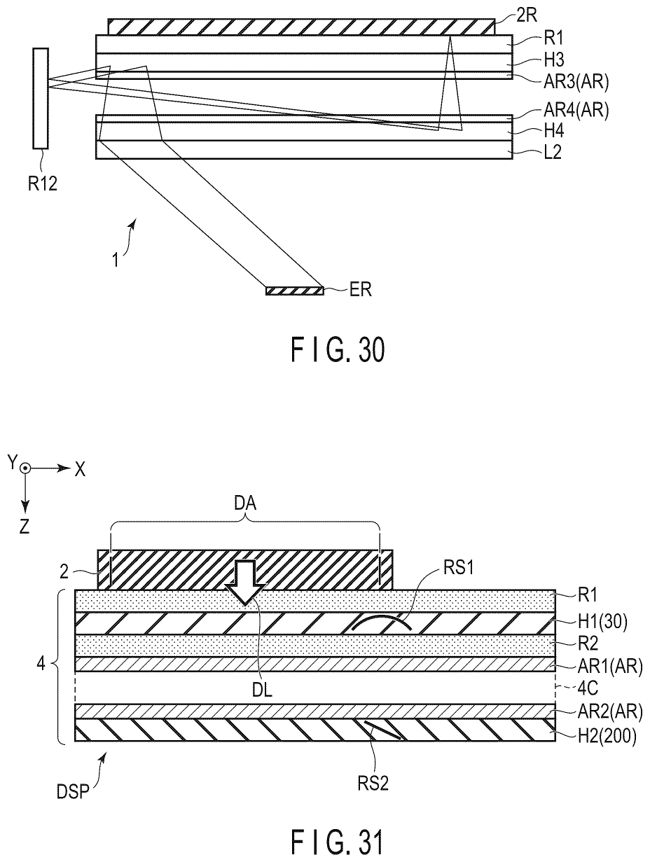

FIG. 30 is a diagram for explaining an optical effect of the head-mounted display 1 illustrated in FIG. 29. Here, an optical path through which display light DLR from the display panel 2R for the right eye reaches the right eye ER will be focused and described. In addition, only one optical path is illustrated because optical paths are complicated. Incidentally, a polarization state of light is as illustrated in FIG. 25, and illustration thereof in FIG. 30 is omitted. The polarization direction is maintained in the display light DL transmitted through the antireflective film AR3 and the antireflective film AR4 similarly to FIG. 25.

First, the display panel 2R emits the display light DLR. The display light DLR is first linearly polarized light LP1. The display light DLR is converted into first circularly polarized light CP1 when the display light DLR is transmitted through the first retardation film R1. The first circularly polarized light CP1 transmitted through the first retardation film R1 is transmitted through the third transflective element H3 (the optical element 200B, the optical element 200G, and the optical element 200R).

The first circularly polarized light CP1 transmitted through the third transflective element H3 is reflected by the fourth transflective element H4 (the optical element 200B, the optical element 200G, and the optical element 200R). The fourth transflective element H4 reflects the first circularly polarized light CP1 toward the second reflective surface R12.

The first circularly polarized light CP1 reflected by the fourth transflective element H4 is reflected by the second reflective surface R12 and is then converted into the second circularly polarized light CP2. The second circularly polarized light CP2 reflected by the second reflective surface R12 is reflected by the third transflective element H3 (the optical element 200B, the optical element 200G, and the optical element 200R). The third transflective element H3 reflects the second circularly polarized light CP2 toward the fourth transflective element H4.

The second circularly polarized light CP2 reflected by the third transflective element H3 is transmitted through the fourth transflective element H4, is then converted into the first circularly polarized light CP1 by the second element L2 (liquid crystal element 10), and is collected on the user's right eye ER due to the lens effect.

The display light DLL from the display panel 2L for the left eye also reaches the left eye EL in a similar manner.

Effects that are similar to those of the first configuration example are obtained even in such a third configuration example.

### Fourth Configuration Example

FIG. 31 is a sectional view illustrating a fourth configuration example of the display device DSP. The fourth configuration example illustrated in FIG. 31 is different from the first configuration example illustrated in FIG. 21 in that the first transflective element H1 includes a concave reflective surface RS1 facing the second transflective element H2 and the first element L1 is omitted.

The display device DSP includes a display panel 2 and an optical system 4. Incidentally, although illustration of the illumination device is omitted and detailed illustration of the display panel 2 is omitted here, the display panel 2 is configured to emit display light DL that is linearly polarized light in the display area DA.

The optical system 4 includes a first retardation film R1, a first transflective element H1, a second retardation film R2, an antireflective film AR1, an antireflective film AR2, and a second transflective element H2. Details of the first retardation film R1 and the second retardation film R2 are as described above in the first configuration example, the first retardation film R1 is in contact with the display panel 2 and the first transflective element H1, and the second retardation film R2 is in contact with the first transflective element H1. Details of the antireflective film AR1 and the antireflective film AR2 are also as described above in the first configuration example.

The first transflective element H1 is interposed between the first retardation film R1 and the second retardation film R2 and includes an optical element 30 including cholesteric liquid crystals as will be described later. The optical element 30 transmits first circularly polarized light out of light of specific wavelengths, reflect second circularly polarized light toward the second transflective element H2, and has a lens effect of collecting the second circularly polarized light. The optical element 30 includes a reflective surface RS1 illustrated in a simplified manner.

The second transflective element H2 includes an optical element 200 including cholesteric liquid crystals as described above in the first configuration example. The optical element 200 is adapted to transmit the second circularly polarized light and reflect the first circularly polarized light toward the first transflective element H1 out of light of the specific wavelengths. The optical element 200 includes a reflective surface RS2 illustrated in a simplified manner. The reflective surface RS2 has a substantially planar shape extending in a specific direction. An angle formed between the reflective surface RS2 and the X-Y plane is an acute angle in a clockwise direction from the X-Y plane. The second transflective element H2 is spaced apart from the second retardation film R2 and faces the second retardation film R2 via the air layer 4C in the third direction Z.

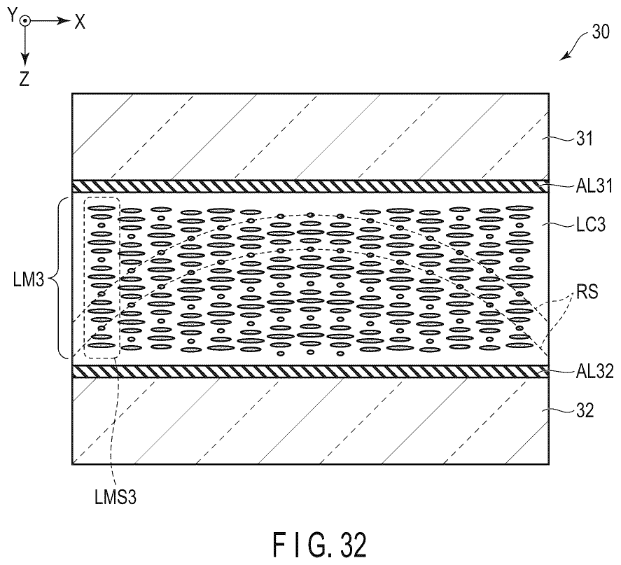

FIG. 32 is a sectional view illustrating an example of the optical element 30 illustrated in FIG. 31.

The optical element 30 includes a substrate 31, an alignment film AL31, a liquid crystal layer (third liquid crystal layer) LC3, an alignment film AL32, and a substrate 32. The substrate 31 and the substrate 32 are transparent substrates that transmit light and are configured of transparent glass plates or transparent synthetic resin plates, for example.

The alignment film AL31 faces the alignment film AL32 in the third direction Z. The alignment films AL31 and AL32 are formed of polyimide, for example, and both of them are horizontal alignment films having an alignment restriction force along the X-Y plane.

The liquid crystal layer LC3 is interposed between the alignment film AL31 and the alignment film AL32 and is in contact with the alignment film AL31 and the alignment film AL32. The liquid crystal layer LC3 includes a liquid crystal structures (cholesteric liquid crystal) LMS3. Incidentally, FIG. 23 illustrates liquid crystal molecules directed in an average alignment direction as representatives from among the plurality of liquid crystal molecules located in the X-Y plane as one liquid crystal molecule LM3 for simplification of the drawing. The plurality of liquid crystal molecules LM3 are stacked in a spiral shape in the third direction Z while swirling and configure the cholesteric liquid crystals.

The liquid crystal layer LC3 includes a plurality of reflective surfaces RS as illustrated by the dashed lines between the alignment film AL31 and the alignment film AL32. The reflective surfaces RS transmit the first circularly polarized light and reflects the second circularly polarized light in the incident light in accordance with the Bragg's rule. The reflective surfaces RS are curved surfaces, are recessed on the side on which they face the substrate 32 or on the side on which they face the second transflective element H2 in FIG. 22 and project on the side on which they face the substrate 31 or on the side on which they face the display panel 2 in FIG. 22.

Such a liquid crystal layer LC3 is cured in a state where the alignment directions of the plurality of liquid crystal molecules LM3 are fixed.

The optical element 30 of the first transflective element H1 illustrated in FIG. 31 includes a liquid crystal layer LC3 including the liquid crystal structures (cholesteric liquid crystal) LMS3 illustrated in FIG. 32. The reflective surface RS1 in the first transflective element H1 illustrated in FIG. 31 corresponds to the reflective surface RS illustrated in FIG. 32.

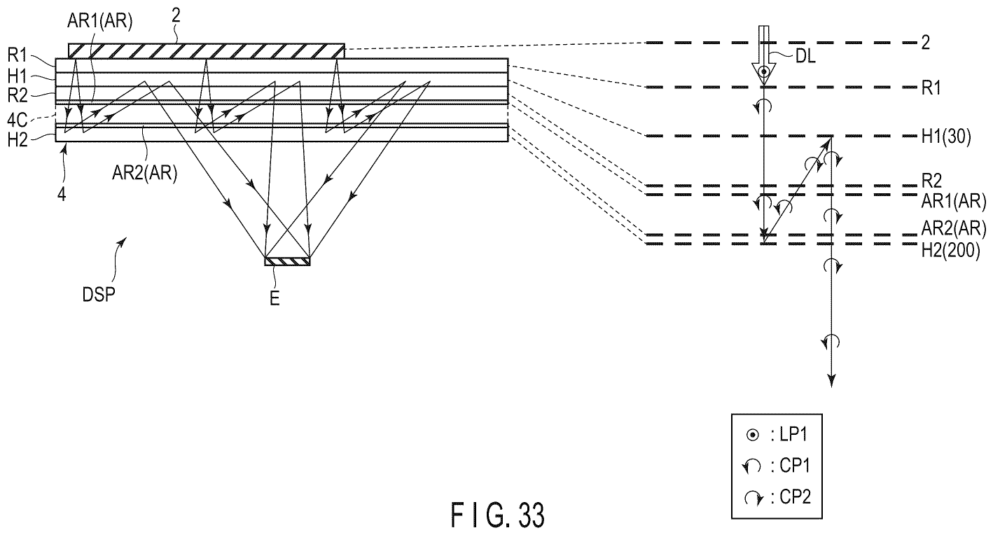

FIG. 33 is a diagram for explaining an optical effect of the display device DSP illustrated in FIG. 31.

Display light DL that is incident on the second transflective element H2 through the second retardation film R2 passes through the antireflective film AR1 and the antireflective film AR2. Display light DL that is incident on the second retardation film R2 through the second transflective element H2 passes through the antireflective film AR2 and the antireflective film AR1. As described above, the polarization direction of the display light DL is maintained in the antireflective film AR1 and the antireflective film AR2.

First, the display panel 2 emits display light DL that is first linearly polarized light LP1. The display light DL is converted into first circularly polarized light CP1 when the display light DLR is transmitted through the first retardation film R1. The first circularly polarized light CP1 transmitted through the first retardation film R1 is transmitted through the first transflective element H1 (optical element 30).

The first circularly polarized light CP1 transmitted through the first transflective element H1 is transmitted substantially perpendicularly through the second retardation film R2 and is then reflected by the second transflective element H2 (optical element 200). The first circularly polarized light CP1 reflected by the second transflective element H2 is converted into second circularly polarized light CP2 when the first circularly polarized light CP1 is transmitted obliquely through the second retardation film R2.

The second circularly polarized light CP2 transmitted through the second retardation film R2 is reflected by the first transflective element H1 (optical element 30). The second circularly polarized light CP2 reflected by the first transflective element H1 is transmitted substantially perpendicularly through the second retardation film R2, is then transmitted through the second transflective element H2, and is collected on the user's pupil E due to the lens effect of the first transflective element H1.

Effects that are similar to those of the first configuration example are obtained even in such a display device DSP. In addition, it is possible to omit the first element and thereby to reduce the number of components.

Incidentally, the first circularly polarized light CP1 described with reference to FIG. 33 may be replaced with the second circularly polarized light CP2.

Effects that are similar to those of the first configuration example are obtained even in such a fourth configuration example.

### Fourth Embodiment

In a fourth embodiment, a display device DSP using an optical system 4 that is different from that in the first embodiment will be described.

Incidentally, the first embodiment will be referred to for components that are similar to those in the first embodiment, and description of these components will be omitted.

### First Configuration Example

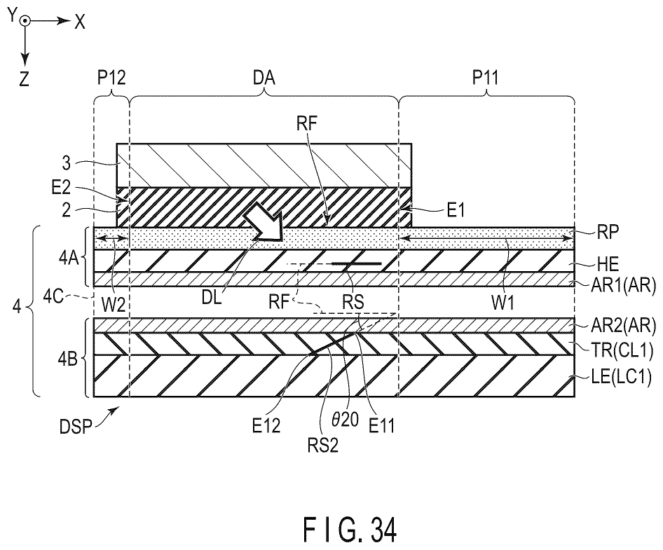

FIG. 34 is a sectional view illustrating a first configuration example of the display device DSP according to the fourth embodiment.

The display device DSP includes a display panel 2, an illumination device 3, and an optical system 4. Incidentally, detailed illustration of the display panel 2 and the illumination device 3 is omitted here. The display device DSP described here can be applied to each of the display device DSPR and the display device DSPL described above. In addition, the display panel 2 can be applied to each of the display panel 2R and the display panel 2L described above. In addition, the illumination device 3 can be applied to each of the illumination device 3R and the illumination device 3L described above. In addition, the optical system 4 can be applied to each of the optical system 4R and the optical system 4L described above.

The optical system 4 includes a first structure 4A and a second structure 4B. The first structure 4A is spaced apart from the second structure 4B. In the example illustrated in FIG. 34, an air layer 4C is provided between the first structure 4A and the second structure 4B. The first structure 4A is interposed between the display panel 2 and the second structure 4B (or between the display panel 2 and the air layer 4C).

The first structure 4A includes a retardation film RP, a holographic optical element HE, and an antireflective film AR1. The retardation film RP is a quarter-wave plate and is configured to impart a phase difference of a quarter wavelength to transmitted light.

The holographic optical element HE has an interference fringe pattern and has a refractive index at a cycle in accordance with the wavelength in the thickness direction (third direction Z). Such a holographic optical element HE is configured to reflect and diffract a part of incident light. More specifically, the holographic optical element HE includes a virtual reflective surface RS1. When the boundary between the display panel 2 and the retardation film RP (or a plane that is parallel to the X-Y plane) is defined as a reference plane RF, the reflective surface RS1 is parallel to the reference plane RF. In other words, an angle θ10 formed between the reflective surface RS1 and the reference plane RF is 0°. The holographic optical element HE is configured to reflect light that is incident at a specific angle of incidence with respect to the normal line of the reflective surface RS1 and transmit light that is incident at an angle of incidence that is different from the specific angle of incidence. This point will be described later in detail.

The retardation film RP, the holographic optical element HE, and the antireflective film AR1 extend in a wider range than a display area DA in the X-Y plane. However, it is only necessary for the retardation film RP to cover at least the display area DA. In addition, the retardation film RP, the holographic optical element HE, and the antireflective film AR1 are laminated in this order in the third direction Z.

The retardation film RP is in contact with the display panel 2. The holographic optical element HE is in contact with the retardation film RP. The antireflective film AR1 is in contact with the holographic optical element HE. The retardation film RP is interposed between the display panel 2 and the holographic optical element HE. The holographic optical element HE is interposed between the retardation film RP and the antireflective film AR1.

The second structure 4B includes an antireflective film AR2, a transflective element TR, and a lens element LE.

The transflective element TR includes a cholesteric liquid crystal layer CL1 including cholesteric liquid crystals swirling in one direction. The cholesteric liquid crystal layer CL1 is configured to reflect circularly polarized light in the same swirling direction as the swirling direction of the cholesteric liquid crystals toward the first structure 4A and transmit circularly polarized light in the swirling direction opposite to the swirling direction of the cholesteric liquid crystals out of light of the specific wavelengths. Here, the circularly polarized light reflected by the cholesteric liquid crystal layer CL1 will be referred to as first circularly polarized light, and the circularly polarized light transmitted through the cholesteric liquid crystal layer CL1 will be referred to as second circularly polarized light.

The cholesteric liquid crystal layer CL1 includes a reflective surface RS2 illustrated in a simplified manner. When the boundary between the display panel 2 and the retardation film RP (or a plane that is parallel to the X-Y plane) is defined as a reference plane RF, an angle (angle of inclination) 020 formed between the reflective surface RS2 and the reference plane RF is an acute angle in the counterclockwise direction from the reference plane RF.

The lens element LE includes a liquid crystal layer LC1. The liquid crystal layer LC1 is configured to impart a phase difference of a half wavelength to light of a specific wavelength and have a lens effect of collecting the second circularly polarized light. Incidentally, the element having the lens effect of collecting the circularly polarized light is not limited to an element using a liquid crystal.

The antireflective film AR2, the transflective element TR, and the lens element LE extend in a wider range than the display area DA in the X-Y plane. In addition, the antireflective film AR2, the transflective element TR, and the lens element LE are laminated in this order in the third direction Z.

The antireflective film AR2 is in contact with the transflective element TR. The transflective element TR is in contact with the lens element LE. The transflective element TR is spaced apart from the holographic optical element HE with the antireflective film AR1 and the antireflective film AR2 sandwiched therebetween. The transflective element TR faces the holographic optical element HE via the antireflective film AR1, the air layer 4C, and the antireflective film AR2 in the third direction Z.

The display area DA includes a first end portion E1 and a second end portion E2 on the side opposite to the first end portion E1 in the first direction X. The holographic optical element HE, the antireflective film AR1, the antireflective film AR2, the transflective element TR, and the lens element LE have a first part P11 extending further outward than the first end portion E1 and a second part P12 extending further outward than the second end portion E2. In the example illustrated in FIG. 34, the first part P11 and the second part P12 extend in the first direction X. The width W1 of the first part P11 in the first direction X is greater than the width W2 of the second part P12 in the first direction X (W1>W2).

In FIG. 34, the first part P11 is located on the right side with respect to the display area DA, and the second part P12 is located on the left side with respect to the display area DA. The reflective surface RS2 of the transflective element TR includes an end portion E11 on the right side (the side on which the first part P11 is located) in the drawing and an end portion E12 on the left side (the side on which the second part is located) in the drawing. The reflective surface RS2 is inclined such that the end portion E11 is located on the side near the display panel 2 and the end portion E12 is located on the side spaced apart from the display panel 2.

It is desirable that the display panel 2 and the retardation film RP be in close contact with each other without intervention of any air layer. In addition, it is desirable that the retardation film RP, the holographic optical element HE, and the antireflective film AR1 configuring the first structure 4A be in close contact with each other without intervention of any air layer.

Moreover, it is desirable that the antireflective film AR2, the transflective element TR, and the lens element LE configuring the second structure 4B be in close contact with each other without intervention of any air layer. As described above, it is possible to suppress undesirable reflection or refraction at an interface between members.

Incidentally, although the retardation film RP is adapted to impart a phase difference of a quarter wavelength to at least light of the green wavelength, for example, the retardation film RP is not limited thereto. For example, it is possible to apply a retardation film of a broadband type imparting a phase difference of an approximately quarter wavelength to light of each of the red wavelength, the green wavelength, and the blue wavelength as the retardation film RP. As such retardation films of a broadband type, it is possible to apply retardation films obtained by attaching quarter-wave plates and half-wave plates in a state where a slow axis of the quarter-wave plates and a slow axis of the half-wave plates form a predetermined angle, for example. It is thus possible to reduce wavelength dependency of the retardation film RP.

As the lens element LE illustrated in FIG. 34, it is possible to use the liquid crystal element 10 illustrated in FIG. 15. In a case where second circularly polarized light of a specific wavelength λ is incident on the lens element LE, the second circularly polarized light is collected toward the center of the concentric circles, and further, the light transmitted through the lens element LE is converted into first circularly polarized light in the direction opposite to that of the second circularly polarized light, similarly to the liquid crystal element 10.

As the transflective element TR illustrated in FIG. 34, it is possible to use the optical element 200 illustrated in FIGS. 22 and 23. However, the reflective surface RS2 of the optical element 200 illustrated in FIGS. 22 and 23 is read as the reflective surface RS instead in the transflective element TR. In addition, the liquid crystal layer LC2 of the optical element 200 illustrated in FIGS. 22 and 23 is read as the cholesteric liquid crystal layer CL1 instead in the transflective element TR.

The liquid crystal structures LMS2 used in the transflective element TR illustrated in FIG. 34 reflect circularly polarized light in the same swirling direction as the swirling direction of the cholesteric liquid crystals out of light of the specific wavelength λ. In a case where the swirling direction of the cholesteric liquid crystals is the clockwise direction, for example, the liquid crystal structures LMS2 reflect clockwise circularly polarized light and transmit counterclockwise circularly polarized light out of the light of the specific wavelength λ. Similarly, in a case where the swirling direction of the cholesteric liquid crystals is the counterclockwise direction, the liquid crystal structures LMS2 reflect counterclockwise circularly polarized light and transmit clockwise circularly polarized light out of the light of the specific wavelength λ.

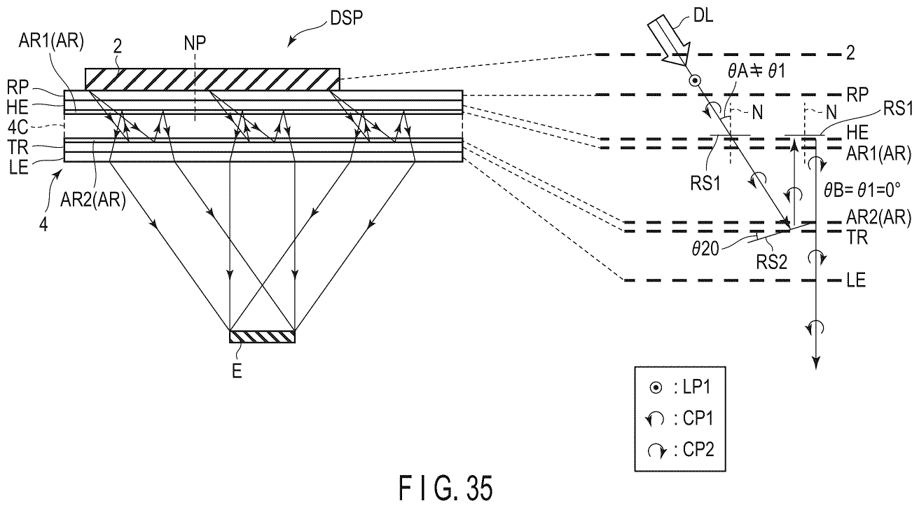

FIG. 35 is a diagram for explaining an example of an optical effect of the display device DSP illustrated in FIG. 34.

Display light DL that is incident on the transflective element TR through the holographic optical element HE passes through the antireflective film AR1 and the antireflective film AR2. Display light DL that is incident on the holographic optical element HE through the transflective element TR passes through the antireflective film AR2 and the antireflective film AR1. As described above, the polarization direction of the display light DL is maintained in the antireflective film AR1 and the antireflective film AR2.

First, the display panel 2 emits the display light DL that is first linearly polarized light LP1. The first linearly polarized light LP1 here is linearly polarized light oscillating in a direction perpendicular to the drawing, for example. The display light DL is emitted in an oblique direction with respect to the normal line NP of the display panel 2. A phase difference of a quarter wavelength is imparted to the display light DL when the display light is transmitted through the retardation film RP. In this manner, the display light DL is converted into the first circularly polarized light CP1 when the display light DL is transmitted through the retardation film RP. The first circularly polarized light CP1 here is counterclockwise circularly polarized light, for example.

The first circularly polarized light CP1 transmitted through the retardation film RP is incident on the holographic optical element HE. An angle of incidence θA of the first circularly polarized light CP1 that is incident on the holographic optical element HE is different from the specific angle of incidence θ1 in the holographic optical element HE. The angle of incidence is an angle formed between a normal line N of the virtual reflective surface RS1 and the incident light. In the example illustrated here, the specific angle of incidence θ1 of the holographic optical element HE is 0°. In other words, the holographic optical element HE is configured to reflect incident light that is parallel to the normal line N. For this reason, the first circularly polarized light CP1 at the angle of incidence θA is transmitted through the holographic optical element HE.

The first circularly polarized light CP1 transmitted through the holographic optical element HE is reflected toward the holographic optical element HE by the reflective surface RS2 of the transflective element TR. Incidentally, the polarization state is maintained when the first circularly polarized light CP1 is reflected by the reflective surface RS2. In other words, the light reflected by the reflective surface RS2 is the first circularly polarized light CP1. The angle of reflection of the first circularly polarized light CP1 is controlled by the angle of inclination θ20 of the reflective surface RS2, and the angle of incidence of the first circularly polarized light CP1 on the holographic optical element HE is set to become a specific angle of incidence θ1. In the example illustrated here, the angle of inclination θ20 is set such that the first circularly polarized light CP1 is reflected in parallel to the normal line N of the holographic optical element HE.

The first circularly polarized light CP1 reflected by the transflective element TR is incident along the normal line N of the holographic optical element HE. An angle of incidence θB of the first circularly polarized light CP1 that is incident on the holographic optical element HE is substantially equal to the specific angle of incidence θ1 in the holographic optical element HE. For this reason, the first circularly polarized light CP1 at the angle of incidence θB is Bragg-reflected (or specular-reflected) by the reflective surface RS1 of the holographic optical element HE. The light reflected by the holographic optical element HE is converted into the second circularly polarized light CP2 in the direction opposite to the direction of the first circularly polarized light CP1. The second circularly polarized light CP2 here is, for example, clockwise circularly polarized light.

The second circularly polarized light CP2 reflected by the holographic optical element HE is transmitted through the transflective element TR. The second circularly polarized light CP2 transmitted through the transflective element TR is converted into the first circularly polarized light CP1 and is collected on the user's pupil E due to the lens effect by the lens element LE.

According to such a display device DSP, the optical system 4 includes an optical path passing between the holographic optical element HE and the transflective element TR three times. Furthermore, the optical path includes an oblique optical path from the holographic optical element HE to the transflective element TR. In other words, the optical distance between the holographic optical element HE and the transflective element TR is equal to or greater than three times the actual interval between the holographic optical element HE and the transflective element TR (or the thickness of the air layer 4C) in the optical system 4. The display panel 2 is installed on the side further inward than the focal point of the lens element LE having the lens effect. The user can thus observe an enlarged virtual image.

According to such a first configuration example, it is possible to collect substantially 100% of display light DL emitted from the display panel 2 on the pupil E if absorption by each member configuring the display device DSP and reflection between the members are ignored, and it is thus possible to improve utilization efficiency of the light.

In addition, it is possible to reduce the thickness in the third direction Z and further to realize a lighter weight as compared with an optical system including optical components formed of glass, a resin, and the like.

Incidentally, the first circularly polarized light CP1 described with reference to FIG. 35 may be replaced with the second circularly polarized light CP2.

### Second Configuration Example

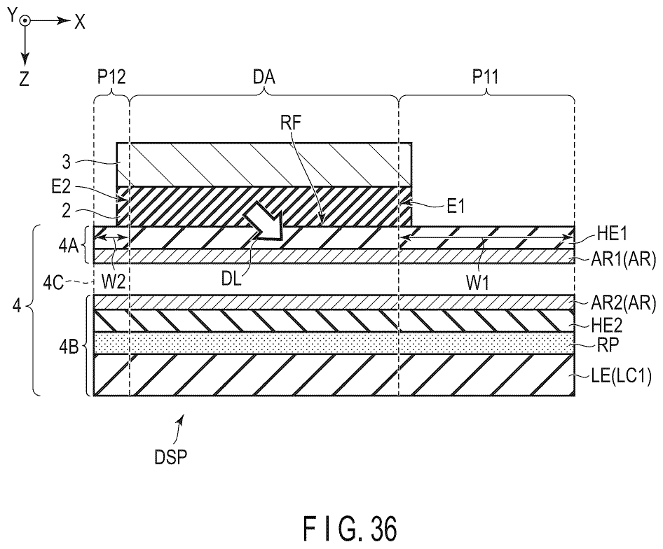

FIG. 36 is a sectional view illustrating a second configuration example of the display device DSP according to the fourth embodiment.

The display device DSP includes a display panel 2, an illumination device 3, and an optical system 4. Incidentally, detailed illustration of the display panel 2 and the illumination device 3 is omitted here. The display device DSP described here can be applied to each of the display device DSPR and the display device DSPL illustrated in FIG. 2. In addition, the display panel 2 can be applied to each of the display panel 2R and the display panel 2L described above. In addition, the illumination device 3 can be applied to each of the illumination device 3R and the illumination device 3L described above. In addition, the optical system 4 can be applied to each of the optical system 4R and the optical system 4L described above.

The second configuration example illustrated in FIG. 36 is different from the first configuration example illustrated in FIG. 34 in the configuration of the optical system 4. Each of the configurations of the display panel 2 and the illumination device 3 is the same as that in the first configuration example, and detailed description thereof will be omitted.

The optical system 4 includes a first structure 4A and a second structure 4B. The first structure 4A is spaced apart from the second structure 4B. In the example illustrated in FIG. 36, an air layer 4C is provided between the first structure 4A and the second structure 4B. The first structure 4A is interposed between the display panel 2 and the second structure 4B (or between the display panel 2 and the air layer 4C).

The first structure 4A includes a first holographic optical element HE1 and an antireflective film AR1. The antireflective film AR1 and the first holographic optical element HE1 extend in a wider range than the display area DA in the X-Y plane. The antireflective film AR1 and the first holographic optical element HE1 are laminated in this order in the third direction Z.

The second structure 4B includes an antireflective film AR2, a second holographic optical element HE2, a retardation film RP, and a lens element LE. The retardation film RP is configured similarly to the retardation film RP in the first configuration example. The lens element LE is configured similarly to the lens element LE in the first configuration example. The antireflective film AR1 and the antireflective film AR2 are configured similarly to the antireflective film AR1 and the antireflective film AR2 in the first configuration example.

Each of the first holographic optical element HE1 and the second holographic optical element HE2 is configured similarly to the holographic optical element HE in the first configuration example.

The first holographic optical element HE1 is configured to reflect light at a first specific angle of incidence and transmit light at an angle of incidence that is different from the first specific angle of incidence. The second holographic optical element HE2 is configured to reflect light at a second specific angle of incidence and transmit light at an angle of incidence that is different from the second specific angle of incidence. The second specific angle of incidence is an angle that is different from the first specific angle of incidence. This point will be described later in detail.

The second holographic optical element HE2, the retardation film RP, and the lens element LE extend in a wider range than the display area DA in the X-Y plane. In addition, the lens element LE, the retardation film RP, the second holographic optical element HE2, and the antireflective film AR2 are laminated in this order in the third direction Z. The second holographic optical element HE2 faces the first holographic optical element HE1 via the antireflective film AR2, the air layer 4C, and the antireflective film AR2 in the third direction Z.

Incidentally, the retardation film RP may be interposed between the display panel 2 and the first holographic optical element HE1.

The first holographic optical element HE1, the antireflective film AR1, the antireflective film AR2, the second holographic optical element HE2, the retardation film RP, and the lens element LE include a first part P11 extending further outward than the first end portion E1 and a second part P12 extending further outward than the second end portion E2. In the example illustrated in FIG. 36, the first part P11 and the second part P12 extend in the first direction X. The width W1 of the first part P11 in the first direction X is greater than the width W2 of the second part P12 in the first direction X (W1>W2).

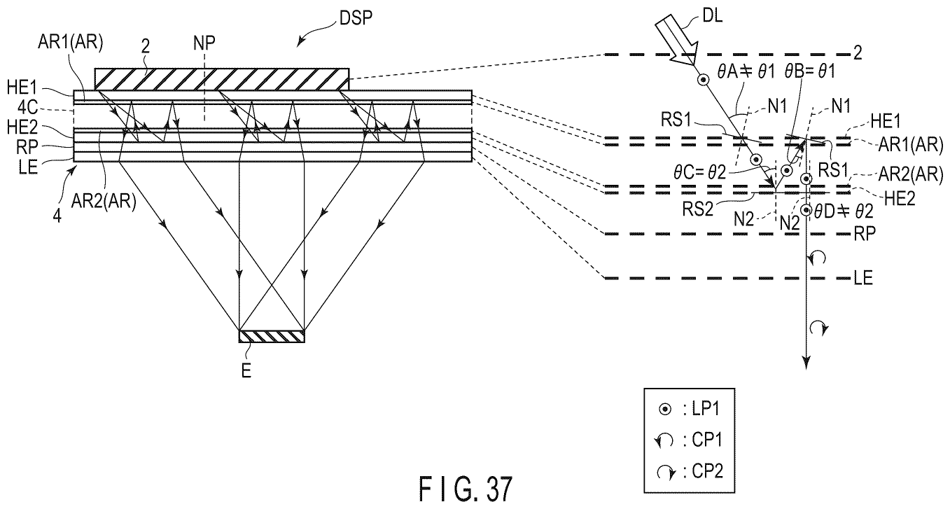

FIG. 37 is a diagram for explaining an example of an optical effect of the display device DSP illustrated in FIG. 36.

Display light DL that is incident on the second holographic optical element HE2 through the first holographic optical element HE1 passes through the antireflective film AR1 and the antireflective film AR2. Display light DL that is incident on the first holographic optical element HE1 through the second holographic optical element HE2 passes through the antireflective film AR2 and the antireflective film AR1. As described above, the polarization direction of the display light DL is maintained in the antireflective film AR1 and the antireflective film AR2.

First, the display panel 2 emits the display light DL that is first linearly polarized light LP1. The display light DL is emitted in an oblique direction with respect to the normal line NP of the display panel 2. The display light DL is incident on the first holographic optical element HE1. An angle of incidence θA of first linearly polarized light LP1 that is incident on the first holographic optical element HE1 is different from the first specific angle of incidence θA of the first holographic optical element HE1. The angle of incidence here is an angle formed between a normal line N1 of the virtual reflective surface RS1 and the incident light. The first linearly polarized light LP1 at the angle of incidence θA is transmitted through the first holographic optical element HE1.

The first linearly polarized light LP1 transmitted through the first holographic optical element HE1 is incident on the second holographic optical element HE2. An angle of incidence ° C. of the first linearly polarized light LP1 that is incident on the second holographic optical element HE2 is substantially equal to the second specific angle of incidence θ2 of the second holographic optical element HE2. The angle of incidence here is an angle formed between a normal line N2 of the virtual reflective surface RS2 and the incident light. The first linearly polarized light LP1 at the angle of incidence θC is reflected toward the first holographic optical element HE1 by the reflective surface RS2 of the second holographic optical element HE2. Incidentally, the polarization state is maintained when the first linearly polarized light LP1 is reflected by the reflective surface RS2. In other words, light reflected by the reflective surface RS2 is the first linearly polarized light LP1.

The first linearly polarized light LP1 reflected by the second holographic optical element HE2 is incident on the first holographic optical element HE1 again. An angle of incidence θB of the first linearly polarized light LP1 that is incident on the first holographic optical element HE1 is substantially equal to the first specific angle of incidence θ1 of the first holographic optical element HE1. For this reason, the first linearly polarized light LP1 at the angle of incidence θB is reflected by the reflective surface RS1 of the first holographic optical element HE1.

The first linearly polarized light LP1 reflected by the first holographic optical element HE1 is incident on the second holographic optical element HE2 again. An angle of incidence θD of the first linearly polarized light LP1 that is incident on the second holographic optical element HE2 is different from the second specific angle of incidence θ2 of the second holographic optical element HE2. For this reason, the first linearly polarized light LP1 at the angle of incidence θD is transmitted through the second holographic optical element HE2.

A phase difference of a quarter wavelength is imparted to the first linearly polarized light LP1 transmitted through the second holographic optical element HE2 when the first linearly polarized light LP1 is transmitted through the retardation film RP. In this manner, the first linearly polarized light LP1 is converted into first circularly polarized light CP1 when the first linearly polarized light LP1 is transmitted through the retardation film RP. The first circularly polarized light CP1 here is counterclockwise circularly polarized light, for example. The first circularly polarized light CP1 transmitted through the retardation film RP is converted into second circularly polarized light CP2 and is collected on the user's pupil E due to the lens effect by the lens element LE.

According to such a display device DSP, the optical system 4 includes an optical path passing between the first holographic optical element HE1 and the second holographic optical element HE2 three times. Moreover, the optical path includes an oblique optical path from the first holographic optical element HE1 to the second holographic optical element HE2 and an oblique optical path from the second holographic optical element HE2 to the first holographic optical element HE1. In other words, the optical distance between the first holographic optical element HE1 and the second holographic optical element HE2 is equal to or greater than three times the actual interval between the first holographic optical element HE1 and the second holographic optical element HE2 (or the thickness of the air layer 4C) in the optical system 4. The display panel 2 is installed on the side further inward than the focal point of the lens element LE having the lens effect. The user can thus observe an enlarged virtual image.

Effects that are similar to those of the first configuration example are obtained even in such a second configuration example.

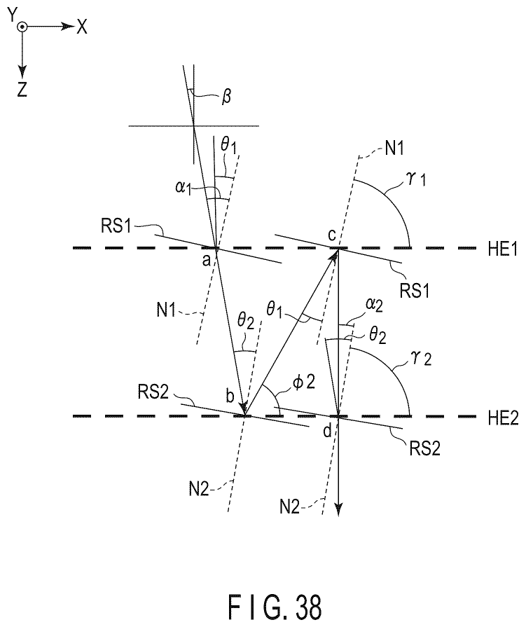

FIG. 38 is a diagram for explaining the first specific angle of incidence θ1 of the first holographic optical element HE1 and the second specific angle of incidence θ2 of the second holographic optical element HE2 illustrated in FIG. 37.

In the first holographic optical element HE1, an angle formed between the normal line N1 of the reflective surface RS1 and the reference plane (X-Y plane) is defined as an angle γ1, and an angle formed between incident light at an angle of incidence β and the normal line N1 is defined as an angle α1.

In the second holographic optical element HE2, an angle formed between the normal line N2 of the reflective surface RS2 and the reference plane (X-Y plane) is defined as an angle γ2, an angle formed between light reflected by the reflective surface RS2 and the reference plane is defined as an angle φ2, and an angle formed between light reflected by the reflective surface RS1 and the normal line N2 is defined as an angle α2.

As indicated by c in the drawing, the following equation is derived based on the condition that the light at the first specific angle of incidence θ1 is reflected by the reflective surface RS1.

γ1=π/2−θ1

As indicated by b in the drawing, the following equation is derived based on the condition that the light at the second specific angle of incidence θ2 is reflected by the reflective surface RS2.

γ2=θ2−2·θ1+π/2

As indicated by a in the drawing, the condition under which the light is transmitted through the first holographic optical element HE1 is as follows.

δ1=α1−θ1≠0

Incidentally, the following relationships are established.

α1=2·θ2+φ2−γ1, φ2=π/2−2·θ1

Based on these relationships, the following equation is derived for δ1.

δ1=2·(θ1−θ2)≠00

Therefore, θ1≠θ2.

As indicated by d in the drawing, the condition under which the light is transmitted through the second holographic optical element HE2 is as follows.

δ2==α2−θ2≠0

Incidentally, the following relationships are established.

α2=π/2−γ2

The following equation is derived for δ2.

δ2=2·(θ1−θ2)≠0

Therefore, θ1≠θ2.

In other words, the optical system 4 in the second configuration example is established by the first specific angle of incidence θ1 being different from the second specific angle of incidence θ2. In addition, a larger difference between the first specific angle of incidence θ1 and the second specific angle of incidence θ2 is more preferable since the condition under which the light is transmitted through the first holographic optical element HE1 and the second holographic optical element HE2 is further alleviated.

At this time, the angle of incidence β is as follows.

β=α1+γ1−π/2=2·(θ2−θ1)

Hereinafter, inventions according to the present disclosure will be additionally described.

[A-1]

A display device including:
a display panel configured to emit display light that is linearly polarized light;
a transflective layer;
a first retardation film that is interposed between the display panel and the transflective layer;
a reflective polarizer that transmits first linearly polarized light and reflects second linearly polarized light that is orthogonal to the first linearly polarized light;
a second retardation film that is interposed between the transflective layer and the reflective polarizer;
an element that is spaced apart from the reflective polarizer; and
a third retardation film that is interposed between the reflective polarizer and the element, wherein
a surface of the second retardation film facing the reflective polarizer is covered with an antireflective film,
the first retardation film, the second retardation film, and the third retardation film are quarter-wave plates, and
the element has a lens effect of collecting first circularly polarized light.

[A-2]

A display device including:
a display panel configured to emit display light that is linearly polarized light;
a transflective layer;
a first retardation film that is interposed between the display panel and the transflective layer;
an element that is spaced apart from the transflective layer; and
a first optical element that is interposed between the transflective layer and the element, is spaced apart from the transflective layer, includes a first cholesteric liquid crystal, reflects first circularly polarized light toward the transflective layer, and transmits second circularly polarized light in a direction opposite to a direction of the first circularly polarized light, wherein
each of a surface of the first retardation film facing the element and a surface of the element facing the first retardation film is covered with an antireflective film,
the first retardation film is a quarter-wave plate, and
the element has a lens effect of collecting the second circularly polarized light.

[A-3]

The display device according to [A-1] or [A-2], wherein
the element includes a liquid crystal layer cured in a state where alignment directions of a plurality of liquid crystal molecules including first liquid crystal molecules and second liquid crystal molecules are fixed,
the liquid crystal layer includes a first annular area in which the plurality of first liquid crystal molecules are aligned in the same direction and a second annular area in which the plurality of second liquid crystal molecules are aligned in the same direction outside the first annular area, in planar view, and
the alignment direction of the first liquid crystal molecules is different from the alignment direction of the second liquid crystal molecules.

[A-4]

The display device according to [A-3], further including:
an illumination device that is disposed on a rear surface of the display panel, wherein
the illumination device includes a first light emitting element configured to emit light of a first wavelength, a second light emitting element configured to emit light of a second wavelength that is a longer wavelength than the first wavelength, and a third light emitting element configured to emit light of a third wavelength that is a longer wavelength than the second wavelength.

[A-5]

The display device according to [A-4], wherein the first light emitting element, the second light emitting element, and the third light emitting element are laser light sources.

[A-6]

The display device according to [A-2], wherein
the first optical element includes a liquid crystal layer cured in a state where an alignment direction of a plurality of liquid crystal molecules is fixed, and
the liquid crystal layer includes the first cholesteric liquid crystal and includes a reflective surface configured to reflect circularly polarized light of a first wavelength.

[B-1]

A display device including:
a display panel that includes a display area configured to emit display light that is linearly polarized light;
a first transflective element that transmits first circularly polarized light and reflects second circularly polarized light in a direction opposite to a direction of the first circularly polarized light;
a first retardation film that is interposed between the display panel and the first transflective element;
a second transflective element that is spaced apart from the first transflective element, reflects the first circularly polarized light, and transmits the second circularly polarized light;
a second retardation film that is interposed between the first transflective element and the second transflective element and has refractive anisotropy in which refractive indexes in mutually orthogonal directions in a plane are substantially equivalent and a refractive index in a normal direction is different from an in-plane refractive index; and
a first element that faces the second transflective element and has a lens effect of collecting the second circularly polarized light, wherein
each of a surface of the second retardation film facing the second transflective element and a surface of the second transflective element facing the second retardation film is covered with an antireflective film.

[B-2]

The display device according to [B-1], wherein
each of the first transflective element and the second transflective element includes a first optical element configured to reflect circularly polarized light of a first wavelength,
the first optical element includes a first cholesteric liquid crystal and includes a liquid crystal layer cured in a state where an alignment direction of a plurality of liquid crystal molecules is fixed,
the liquid crystal layer includes a reflective surface in which the liquid crystal molecules have the same alignment direction,
the reflective surface is inclined with respect to a main surface of the liquid crystal layer, and
in the first optical element of the first transflective element and the first optical element of the second transflective element, the first cholesteric liquid crystals have an equivalent first spiral pitch and swirl in mutually opposite directions.

[B-3]

The display device according to [B-2], wherein
each of the first transflective element and the second transflective element further includes
a second optical element that includes a second cholesteric liquid crystal and reflects circularly polarized light of a second wavelength that is a longer wavelength than the first wavelength, and
a third optical element that includes a third cholesteric liquid crystal and reflects circularly polarized light of a third wavelength that is a longer wavelength than the second wavelength,
the first optical element, the second optical element, and the third optical element are laminated,
the second cholesteric liquid crystal has a second spiral pitch that is greater than the first spiral pitch, and
the third cholesteric liquid crystal has a third spiral pitch that is greater than the second spiral pitch.

[B-4]

The display device according to [B-3], further including:
an illumination device that is disposed on a rear surface of the display panel, wherein
the illumination device includes a first light emitting element configured to emit light of the first wavelength, a second light emitting element configured to emit light of the second wavelength, and a third light emitting element configured to emit light of the third wavelength.

[B-5]

The display device according to [B-4], wherein each of the first light emitting element, the second light emitting element, and the third light emitting element is a laser light source.

[B-6]

The display device according to [B-1], wherein
the display area includes a first end portion and a second end portion on a side opposite to the first end portion,
the first transflective element, the second retardation film, the second transflective element, and the first element have a first part extending further outward than the first end portion and a second part extending further outward than the second end portion, and
a width of the first part is greater than a width of the second part.

[B-7]

The display device according to [B-6], wherein
each of the first transflective element and the second transflective element includes a reflective surface, and
the reflective surface is inclined such that an end portion on a side on which the first part is located is spaced apart from the display panel and an end portion on a side located at the second part is located near the display panel.

[B-8]

A head-mounted display including:
a first display device including
a first display panel that includes a display area configured to emit display light that is linearly polarized light,
a first transflective element configured to transmit first circularly polarized light and reflect second circularly polarized light in a direction opposite to a direction of the first circularly polarized light,
a first retardation film that is interposed between the first display panel and the first transflective element,
a second transflective element that is spaced apart from the first transflective element, reflects the first circularly polarized light, and transmits the second circularly polarized light, and
a first element that faces the second transflective element and has a lens effect of collecting the second circularly polarized light,
wherein each of a surface of the first retardation film facing the second transflective element and a surface of the second transflective element facing the first retardation film is covered with an antireflective film;
a second display device including
a second display panel that includes a display area configured to emit display light that is linearly polarized light,
a third transflective element configured to transmit third circularly polarized light and reflect fourth circularly polarized light in a direction opposite to a direction of the third circularly polarized light,
the first retardation film that is interposed between the second display panel and the third transflective element,
a fourth transflective element that is spaced apart from the third transflective element, reflects the third circularly polarized light, and transmits the fourth circularly polarized light, and
a second element that faces the fourth transflective element and has a lens effect of collecting the fourth circularly polarized light,
wherein each of a surface of the second retardation film facing the second transflective element and a surface of the second transflective element facing the second retardation film is covered with an antireflective film; and
a second retardation film that is interposed between the first transflective element and the third transflective element and between the second transflective element and the fourth transflective element and has refractive anisotropy in which refractive indexes in mutually orthogonal directions in a plane are substantially equivalent and a refractive index in a normal direction is different from an in-plane refractive index, wherein
a reflective surface of the first transflective element and a reflective surface of the third transflective element have mutually different directions,
a reflective surface of the second transflective element and a reflective surface of the fourth transflective element have mutually different directions, and
a position at which light is collected by the first element and a position at which light is collected by the second element are different from each other.

[B-9]

The head-mounted display according to [B-1], wherein
the first element includes a liquid crystal layer cured in a state where alignment directions of a plurality of liquid crystal molecules including first liquid crystal molecules and second liquid crystal molecules are fixed,
the liquid crystal layer includes a first annular area in which the plurality of first liquid crystal molecules are aligned in the same direction and a second annular area in which the plurality of second liquid crystal molecules are aligned in the same direction outside the first annular area, in planar view, and
the alignment direction of the first liquid crystal molecules is different from the alignment direction of the second liquid crystal molecules.

[B-10]

The head-mounted display according to [B-9], further comprising:
an illumination device that is disposed on a rear surface of the display panel, wherein
the illumination device includes a first light emitting element configured to emit light of a first wavelength, a second light emitting element configured to emit light of a second wavelength, and a third light emitting element configured to emit light of a third wavelength.

[B-11]

The head-mounted display according to [B-10], wherein each of the first light emitting element, the second light emitting element, and the third light emitting element is a laser light source.

[C-1]

A display device including:
a display panel that includes a polarizer and a display area configured to emit display light that is linearly polarized light;
a holographic optical element configured to reflect light at a specific angle of incidence and transmits light at an angle of incidence that is different from the specific angle of incidence;
a retardation film that is interposed between the display panel and the holographic optical element;
a first antireflective film that is disposed in contact with the holographic optical element;
a second antireflective film that faces the first antireflective film with an interval therebetween;
a transflective element that faces the holographic optical element with an interval therebetween via the first antireflective film and the second antireflective film, reflects first circularly polarized light, and transmits second circularly polarized light in a direction opposite to a direction of the first circularly polarized light, of light transmitted through the holographic optical element; and
a lens element that faces the transflective element and has a lens effect of collecting the second circularly polarized light transmitted through the transflective element.

[C-2]

The display device according to [C-1], wherein the specific angle of incidence is 0°.

[C-3]

The display device according to [C-1], further including:
an illumination device that is disposed on a rear surface of the display panel, wherein
the illumination device includes a first light emitting element configured to emit light of a first wavelength, a second light emitting element configured to emit light of a second wavelength that is different from the first wavelength, and a third light emitting element configured to emit light of a third wavelength that is different from the first wavelength and the second wavelength.

[C-4]

The display device according to [C-3], wherein each of the first light emitting element, the second light emitting element, and the third light emitting element is a laser light source.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A display device comprising:
a display panel configured to emit display light that is linearly polarized light;
a first retardation film that faces the display panel;
a holographic optical element that is bonded to the first retardation film;
a second retardation film that is bonded to the holographic optical element; and
a reflective polarizer that faces the second retardation film, reflects first linearly polarized light, and transmits second linearly polarized light that is orthogonal to the first linearly polarized light, wherein
an air layer is interposed between the second retardation film and the reflective polarizer,
a surface of the second retardation film facing the reflective polarizer is covered with an antireflective film.

2. The display device according to claim 1, wherein the first retardation film is bonded to the display panel.

3. The display device according to claim 1, wherein
an air layer is interposed between the first retardation film and the display panel, and
a surface of the first retardation film facing the display panel is covered with an antireflective film.

4. A display device comprising:
a display panel configured to emit display light that is linearly polarized light;
a first retardation film that faces the display panel;
a holographic optical element that is bonded to the first retardation film;
a second retardation film that faces the holographic optical element; and
a reflective polarizer that is bonded to the second retardation film, reflects first linearly polarized light, and transmits second linearly polarized light that is orthogonal to the first linearly polarized light, wherein
an air layer is interposed between the holographic optical element and the second retardation film,
each of a surface of the holographic optical element facing the second retardation film and a surface of the second retardation film facing the holographic optical element is covered with an antireflective film.

5. The display device according to claim 4, wherein the first retardation film is bonded to the display panel.

6. The display device according to claim 4, wherein
an air layer is interposed between the first retardation film and the display panel, and
a surface of the first retardation film facing the display panel is covered with an antireflective film.

7. A display device comprising:
a display panel configured to emit display light that is linearly polarized light;
a first retardation film that faces the display panel;
a holographic optical element that faces the first retardation film;
a second retardation film that faces the holographic optical element; and
a reflective polarizer that faces the second retardation film, reflects first linearly polarized light, and transmits second linearly polarized light that is orthogonal to the first linearly polarized light, wherein
air layers is interposed each between the first retardation film and the display panel, between the holographic optical element and the first retardation film, between the second retardation film and the holographic optical element, and between the reflective polarizer and the second retardation film,
each of a surface of the first retardation film facing the display panel, a surface of the first retardation film facing the holographic optical element, a surface of the holographic optical element facing the first retardation film, a surface of the holographic optical element facing the second retardation film, a surface of the second retardation film facing the holographic optical element, and a surface of the second retardation film facing the reflective polarizer being covered with an antireflective film.

8. The display device according to claim 1, wherein the first retardation film and the second retardation film are quarter-wave plates.

9. The display device according to claim 1, wherein the display panel includes a liquid crystal panel and a polarizer that faces the first retardation film.

10. The display device according to claim 9, further comprising:
an illumination device that illuminates the liquid crystal panel, wherein
the illumination device includes a first laser element configured to emit blue laser light, a second laser element configured to emit green laser light, and a third laser element configured to emit red laser light.

11. The display device according to claim 4, wherein the first retardation film and the second retardation film are quarter-wave plates.

12. The display device according to claim 4, wherein the display panel includes a liquid crystal panel and a polarizer that faces the first retardation film.

13. The display device according to claim 12, further comprising:
an illumination device that illuminates the liquid crystal panel, wherein
the illumination device includes a first laser element configured to emit blue laser light, a second laser element configured to emit green laser light, and a third laser element configured to emit red laser light.

14. The display device according to claim 7, wherein the first retardation film and the second retardation film are quarter-wave plates.

15. The display device according to claim 7, wherein the display panel includes a liquid crystal panel and a polarizer that faces the first retardation film.

16. The display device according to claim 15, further comprising:
an illumination device that illuminates the liquid crystal panel, wherein
the illumination device includes a first laser element configured to emit blue laser light, a second laser element configured to emit green laser light, and a third laser element configured to emit red laser light.
